(19) United States
(12) Patent Application Publication
(10) Pub. No.: US 2015/0243292 A1
(43) Pub. Date: Aug. 27, 2015

(54) ORDER FORMAT SIGNALING FOR HIGHER-ORDER AMBISONIC AUDIO DATA

(71) Applicant: QUALCOMM Incorporated, San Diego, CA (US)

(72) Inventors: Martin James Morrell, San Diego, CA (US); Nils Günther Peters, San Diego, CA (US); Dipanjan Sen, San Diego, CA (US)

(21) Appl. No.: 14/630,165

(22) Filed: Feb. 24, 2015

Related U.S. Application Data
(60) Provisional application No. 61/944,503, filed on Feb. 25, 2014.
(60) Provisional application No. 62/004,113, filed on May 28, 2014.

(51) Int. Cl. G10L 19/008; G10L 19/02

(52) U.S. Cl. CPC G10L 19/008; G10L 19/0204

(57) ABSTRACT

In general, techniques are described for signaling an order format for higher-order ambisonic audio data. An audio decoding device including a memory and a processor may perform the techniques. The memory may be configured to store a bitstream indicative of a coded higher-order ambisonic (HOA) audio signal. The processor may be configured to obtain, from the bitstream, a harmonic coefficient ordering format indicator indicative of a symmetric harmonic coefficient ordering format for a source set of HOA coefficients from which the coded HOA audio signal is generated. The processor may further be configured to decode the coded HOA audio signal based on the symmetric harmonic coefficient ordering format indicator.

This application claims the benefit of the following U.S. Provisional applications:

U.S. Provisional Application No. 61/944,503, filed Feb. 25, 2014, entitled “HARMONIC COEFFICIENT ORDERING FORMAT INDICATOR;” and

U.S. Provisional Application No. 62/004,113, filed May 28, 2014, entitled “HARMONIC COEFFICIENT ORDERING FORMAT INDICATOR.”

### TECHNICAL FIELD

This disclosure relates to audio data and, more specifically, representing higher-order ambisonic audio data in a bitstream.

### BACKGROUND

A higher-order ambisonics (HOA) signal (often represented by a plurality of spherical harmonic coefficients (SHC) or other hierarchical elements) is a three-dimensional representation of a soundfield. The HOA or SHC representation may represent the soundfield in a manner that is independent of the local speaker geometry used to playback a multi-channel audio signal rendered from the SHC signal. The SHC signal may also facilitate backwards compatibility as the SHC signal may be rendered to well-known and highly adopted multi-channel formats, such as a 5.1 audio channel format or a 7.1 audio channel format. The SHC representation may therefore enable a better representation of a soundfield that also accommodates backward compatibility.

The HOA representation may refer to samples of HOA coefficients. Each sample of HOA coefficients may represent the soundfield at a given instance in time. The samples of HOA coefficients may include an HOA coefficient corresponding to a hierarchical expansion of spherical basis functions up to a defined maximum order. In other words, the spherical basis functions may be associated with an order from zero up to the defined maximum order, where this defined maximum order may be selected as a function of the desired spatial resolution for representing the soundfield. The spherical basis function of a given order may be further differentiated by a so-called “sub-order.” The number of spherical basis functions for a given maximum order, N, may be defined as (N+1)². For a maximum order of 4, the total number of spherical basis functions is 25 and each sample would therefore have 25 HOA coefficients corresponding to each of the spherical basis functions.

There are a number of ways by which to represent the HOA coefficients in each sample when specified as a linear array (as is common, for example, when specifying a bitstream of coded HOA coefficients). Some representations order the HOA coefficients in each sample in a numerically increasingly sequence (e.g., by order:sub-order as follows: 0:0|1:−1|1:0|1:−1| etc.). Other representations order the HOA coefficients of each sample in a numerically decreasing sequence (e.g., by order:sub-order as follows: 0:0|1:1|1:0|1:−1| etc.). The various ways by which to signal the ordering format may allow for flexibility in specifying the samples of HOA coefficients.

### SUMMARY

In general, techniques are described for signaling a harmonic coefficient ordering format that is used for encoding a higher order ambisonics (HOA) audio signal. The techniques for signaling a harmonic coefficient ordering format may place a harmonic coefficient ordering format indicator into a coded bitstream for an HOA audio signal. The harmonic coefficient ordering format indicator may indicate according to which of a plurality of harmonic coefficient ordering formats a source set of harmonic coefficients is formatted. Placing a harmonic coefficient ordering format indicator into a coded bitstream for an HOA audio signal may allow an audio decoder device to determine which harmonic coefficient ordering format was used for coding a source set of harmonic coefficients that corresponds to a coded set of harmonic coefficients, and to appropriately decode the coded set of harmonic coefficients based on which harmonic coefficient ordering formats was used.

In this way, an audio decoder device may be configurable to automatically detect and support multiple different types of harmonic coefficient ordering formats, including the numerically increasing ordering sequence and a symmetrical ordering sequence (e.g., by order:sub-order as follows: 0:0|1:1|1:−1|1:0| etc.). The symmetrical ordering sequence may facilitate coding of the HOA coefficients using a psychoacoustic audio coder (such as a unified speech and audio coder), as the psychoacoustic audio coder may operate on pairs of HOA coefficients (e.g., the HOA coefficients from a frame of samples corresponding to order:sub-order 1:1 and 1:−1).

In one aspect, a method of decoding a coded higher-order ambisonic (HOA) audio signal comprises obtaining, from a bitstream indicative of the coded HOA audio signal, a harmonic coefficient ordering format indicator indicative of a symmetric harmonic coefficient ordering format for a source set of HOA coefficients from which the coded HOA audio signal is generated. The method also comprises decoding the coded HOA audio signal based on the symmetric harmonic coefficient ordering format indicator.

In another aspect, an audio decoding device comprises a memory configured to store a bitstream indicative of a coded higher-order ambisonic (HOA) audio signal. The audio decoding device further comprises one or more processors configured to obtain, from the bitstream, a harmonic coefficient ordering format indicator indicative of a symmetric harmonic coefficient ordering format for a source set of HOA coefficients from which the coded HOA audio signal is generated, and decode the coded HOA audio signal based on the symmetric harmonic coefficient ordering format indicator.

In another aspect, a method of encoding a higher-order ambisonic (HOA) audio signal comprises generating a bitstream indicative of a coded HOA audio signal and a harmonic coefficient ordering format indicator indicative of a symmetric harmonic coefficient ordering format for a source set of harmonic coefficients from which the coded HOA audio signal is generated.

In another aspect, an audio encoding device comprises a memory configured to store a bitstream indicative of a coded higher-order ambisonic (HOA) audio signal. The audio encoding device further comprises one or more processors configured to generate the bitstream to include a harmonic coefficient ordering format indicator indicative of a symmetric harmonic coefficient ordering format for a source set of harmonic coefficients from which the coded HOA audio signal is generated.

The details of one or more aspects of the techniques are set forth in the accompanying drawings and the description below. Other features, objects, and advantages of the techniques will be apparent from the description and drawings, and from the claims.

### BRIEF DESCRIPTION OF DRAWINGS

FIG. 1 is a diagram illustrating spherical harmonic basis functions of various orders and sub-orders.

FIG. 2 is a diagram illustrating a system that may perform various aspects of the techniques described in this disclosure.

FIG. 3 is a block diagram illustrating, in more detail, one example of the audio encoding device shown in the example of FIG. 2 that may perform various aspects of the techniques described in this disclosure.

FIG. 4 is a block diagram illustrating the audio decoding device of FIG. 2 in more detail.

FIG. 5A is a flowchart illustrating exemplary operation of an audio encoding device in performing various aspects of the vector-based synthesis techniques described in this disclosure.

FIG. 5B is a flowchart illustrating exemplary operation of an audio encoding device in performing various aspects of the coding techniques described in this disclosure.

FIG. 6A is a flowchart illustrating exemplary operation of an audio decoding device in performing various aspects of the techniques described in this disclosure.

FIG. 6B is a flowchart illustrating exemplary operation of an audio decoding device in performing various aspects of the coding techniques described in this disclosure.

FIG. 7 is a conceptual diagram illustrating a higher-order ambisonic (HOA) audio frame that includes a harmonic coefficient ordering format indicator according to techniques described in this disclosure.

FIG. 8 is a diagram illustrating a portion of the bitstream that may specify the compressed spatial components in more detail.

FIGS. 9A and 9B are diagrams illustrating various harmonic coefficient ordering formats selectable for use in representing the HOA coefficients in accordance with various aspects of the techniques described in this disclosure.

### DETAILED DESCRIPTION

The evolution of surround sound has made available many output formats for entertainment nowadays. Examples of such consumer surround sound formats are mostly ‘channel’ based in that they implicitly specify feeds to loudspeakers in certain geometrical coordinates. The consumer surround sound formats include the popular 5.1 format (which includes the following six channels: front left (FL), front right (FR), center or front center, back left or surround left, back right or surround right, and low frequency effects (LFE)), the growing 7.1 format, various formats that includes height speakers such as the 7.1.4 format and the 22.2 format (e.g., for use with the Ultra High Definition Television standard). Non-consumer formats can span any number of speakers (in symmetric and non-symmetric geometries) often termed ‘surround arrays’. One example of such an array includes 32 loudspeakers positioned on coordinates on the corners of a truncated icosahedron.

The input to a future MPEG encoder is optionally one of three possible formats: (i) traditional channel-based audio (as discussed above), which is meant to be played through loudspeakers at pre-specified positions; (ii) object-based audio, which involves discrete pulse-code-modulation (PCM) data for single audio objects with associated metadata containing their location coordinates (amongst other information); and (iii) scene-based audio, which involves representing the soundfield using coefficients of spherical harmonic basis functions (also called “spherical harmonic coefficients” or SHC, “Higher-order Ambisonics” or HOA, and “HOA coefficients”). The future MPEG encoder may be described in more detail in a document entitled “Call for Proposals for 3D Audio,” by the International Organization for Standardization/International Electrotechnical Commission (ISO)/(IEC) JTC1/SC29/WG11/N13411, released January 2013 in Geneva, Switzerland, and available at http://mpeg.chiariglione.org/sites/default/files/files/standards/parts/docs/w13411.zip.

There are various ‘surround-sound’ channel-based formats in the market. They range, for example, from the 5.1 home theatre system (which has been the most successful in terms of making inroads into living rooms beyond stereo) to the 22.2 system developed by NHK (Nippon Hoso Kyokai or Japan Broadcasting Corporation). Content creators (e.g., Hollywood studios) would like to produce the soundtrack for a movie once, and not spend effort to remix it for each speaker configuration. Recently, Standards Developing Organizations have been considering ways in which to provide an encoding into a standardized bitstream and a subsequent decoding that is adaptable and agnostic to the speaker geometry (and number) and acoustic conditions at the location of the playback (involving a renderer).

To provide such flexibility for content creators, a hierarchical set of elements may be used to represent a soundfield. The hierarchical set of elements may refer to a set of elements in which the elements are ordered such that a basic set of lower-ordered elements provides a full representation of the modeled soundfield. As the set is extended to include higher-order elements, the representation becomes more detailed, increasing resolution.

One example of a hierarchical set of elements is a set of spherical harmonic coefficients (SHC). The following expression demonstrates a description or representation of a soundfield using SHC:

$${p}_{i} ( t , {r}_{r} , {θ}_{r} , {ϕ}_{r} ) = {\sum }_{ω = 0}^{∞} [ 4 π {\sum }_{n = 0}^{∞} {j}_{n} ( {kr}_{r} ) {\sum }_{m = - n}^{n} {A}_{n}^{m} ( k ) {Y}_{n}^{m} ( {θ}_{r} , {ϕ}_{r} ) ] {e}^{j ω t} ,$$

The expression shows that the pressure pᵢ at any point {rᵣ, θᵣ, φᵣ} of the soundfield, at time t, can be represented uniquely by the SHC, Aₙ^{m}(k). Here,

$$k = \frac{ω}{c} ,$$

c is the speed of sound (˜343 m/s), {rᵣ, θᵣ, φᵣ} is a point of reference (or observation point), jₙ(•) is the spherical Bessel function of order n, and Yₙ^{m}(θᵣ, φᵣ) are the spherical harmonic basis functions of order n and suborder m. It can be recognized that the term in square brackets is a frequency-domain representation of the signal (i.e., S(ω, rᵣ, θᵣ, φᵣ)) which can be approximated by various time-frequency transformations, such as the discrete Fourier transform (DFT), the discrete cosine transform (DCT), or a wavelet transform. Other examples of hierarchical sets include sets of wavelet transform coefficients and other sets of coefficients of multiresolution basis functions.

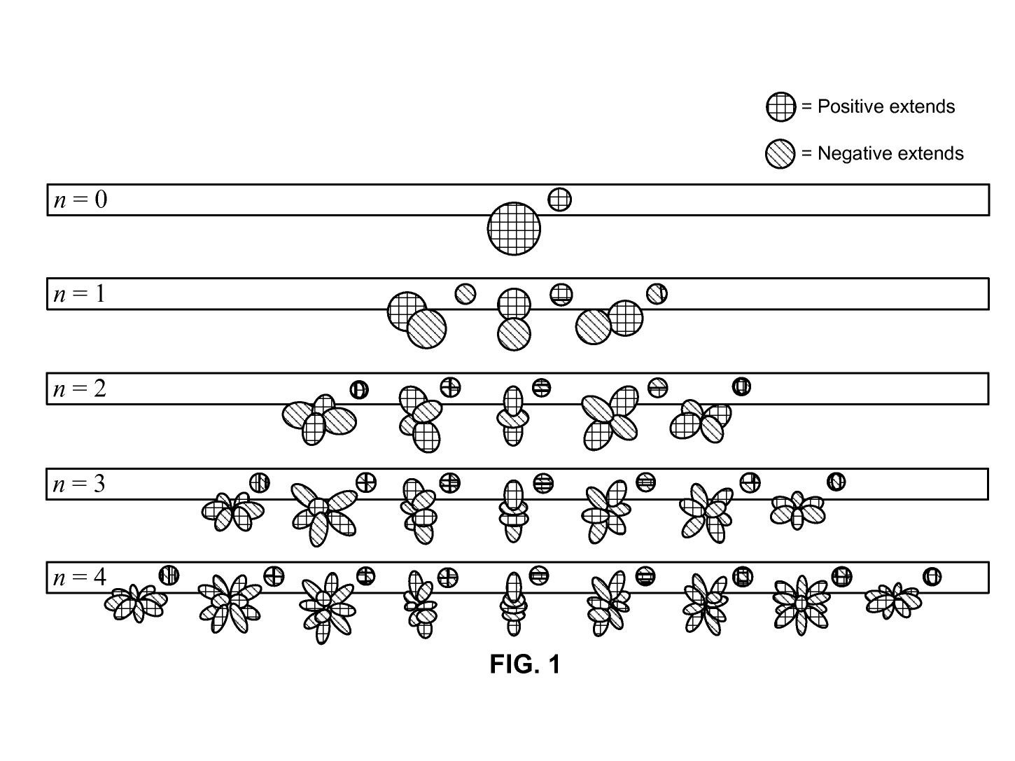

FIG. 1 is a diagram illustrating spherical harmonic basis functions from the zero order (n=0) to the fourth order (n=4). As can be seen, for each order, there is an expansion of suborders m which are shown but not explicitly noted in the example of FIG. 1 for ease of illustration purposes.

The SHC Aₙ^{m}(k) can either be physically acquired (e.g., recorded) by various microphone array configurations or, alternatively, they can be derived from channel-based or object-based descriptions of the soundfield. The SHC represent scene-based audio, where the SHC may be input to an audio encoder to obtain encoded SHC that may promote more efficient transmission or storage. For example, a fourth-order representation involving (1+4)² (25, and hence fourth order) coefficients may be used.

As noted above, the SHC may be derived from a microphone recording using a microphone array. Various examples of how SHC may be derived from microphone arrays are described in Poletti, M., “Three-Dimensional Surround Sound Systems Based on Spherical Harmonics,” J. Audio Eng. Soc., Vol. 53, No. 11, 2005 November, pp. 1004-1025.

To illustrate how the SHCs may be derived from an object-based description, consider the following equation. The coefficients Aₙ^{m}(k) for the soundfield corresponding to an individual audio object may be expressed as:

Aₙ^{m}(k)=g(ω)(−4πik)hₙ⁽²⁾(krₛ)Yₙ^{m*}(θₛ,φₛ),

where i is \sqrt{−1}, hₙ⁽²⁾(•) is the spherical Hankel function (of the second kind) of order n, and {rₛ, θₛ, φₛ} is the location of the object. Knowing the object source energy g(ω) as a function of frequency (e.g., using time-frequency analysis techniques, such as performing a fast Fourier transform on the PCM stream) allows us to convert each PCM object and the corresponding location into the SHC Aₙ^{m}(k). Further, it can be shown (since the above is a linear and orthogonal decomposition) that the Aₙ^{m}(k) coefficients for each object are additive. In this manner, a multitude of PCM objects can be represented by the Aₙ^{m}(k) coefficients (e.g., as a sum of the coefficient vectors for the individual objects). Essentially, the coefficients contain information about the soundfield (the pressure as a function of 3D coordinates), and the above represents the transformation from individual objects to a representation of the overall soundfield, in the vicinity of the observation point {rᵣ, θᵣ, φᵣ}. The remaining figures are described below in the context of object-based and SHC-based audio coding.

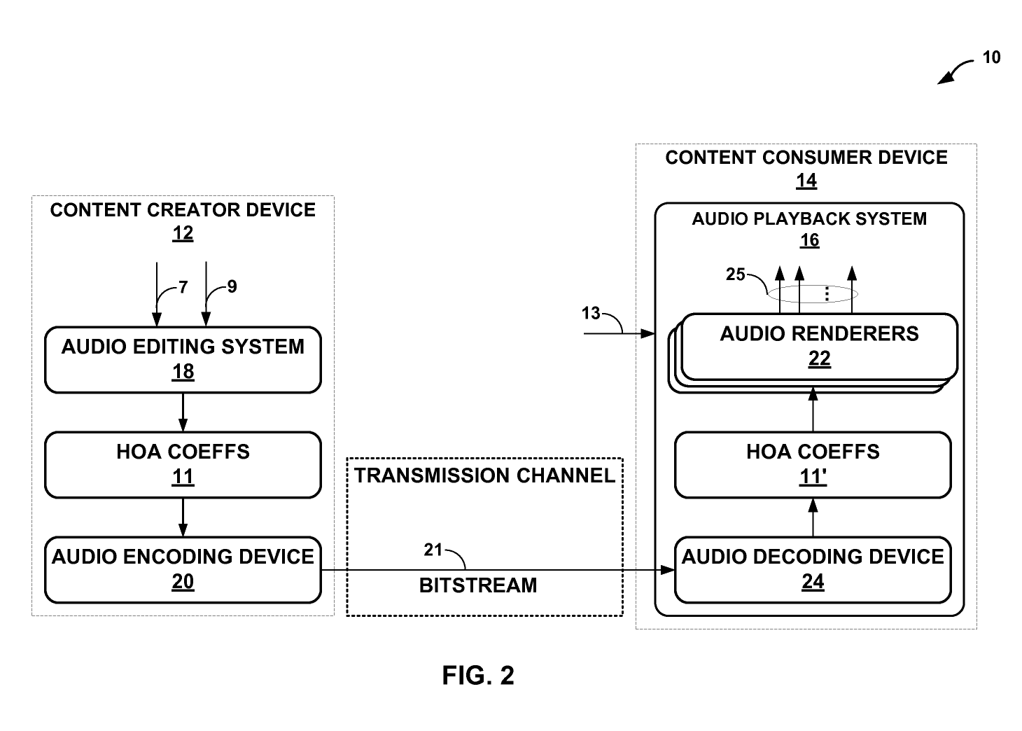

FIG. 2 is a diagram illustrating a system 10 that may perform various aspects of the techniques described in this disclosure. As shown in the example of FIG. 2, the system 10 includes a content creator device 12 and a content consumer device 14. While described in the context of the content creator device 12 and the content consumer device 14, the techniques may be implemented in any context in which SHCs (which may also be referred to as HOA coefficients) or any other hierarchical representation of a soundfield are encoded to form a bitstream representative of the audio data. Moreover, the content creator device 12 may represent any form of computing device capable of implementing the techniques described in this disclosure, including a handset (or cellular phone), a tablet computer, a smart phone, or a desktop computer to provide a few examples. Likewise, the content consumer device 14 may represent any form of computing device capable of implementing the techniques described in this disclosure, including a handset (or cellular phone), a tablet computer, a smart phone, a set-top box, or a desktop computer to provide a few examples.

The content creator device 12 may be operated by a movie studio or other entity that may generate multi-channel audio content for consumption by operators of content consumer devices, such as the content consumer device 14. In some examples, the content creator device 12 may be operated by an individual user who would like to compress HOA coefficients 11. Often, the content creator generates audio content in conjunction with video content. The content consumer device 14 may be operated by an individual. The content consumer device 14 may include an audio playback system 16, which may refer to any form of audio playback system capable of rendering SHC for play back as multi-channel audio content.

The content creator device 12 includes an audio editing system 18. The content creator device 12 obtain live recordings 7 in various formats (including directly as HOA coefficients) and audio objects 9, which the content creator device 12 may edit using audio editing system 18. The content creator may, during the editing process, render HOA coefficients 11 from audio objects 9, listening to the rendered speaker feeds in an attempt to identify various aspects of the soundfield that require further editing. The content creator device 12 may then edit HOA coefficients 11 (potentially indirectly through manipulation of different ones of the audio objects 9 from which the source HOA coefficients may be derived in the manner described above). The content creator device 12 may employ the audio editing system 18 to generate the HOA coefficients 11. The audio editing system 18 represents any system capable of editing audio data and outputting the audio data as one or more source spherical harmonic coefficients.

When the editing process is complete, the content creator device 12 may generate a bitstream 21 based on the HOA coefficients 11. That is, the content creator device 12 includes an audio encoding device 20 that represents a device configured to encode or otherwise compress HOA coefficients 11 in accordance with various aspects of the techniques described in this disclosure to generate the bitstream 21. The audio encoding device 20 may generate the bitstream 21 for transmission, as one example, across a transmission channel, which may be a wired or wireless channel, a data storage device, or the like. The bitstream 21 may represent an encoded version of the HOA coefficients 11 and may include a primary bitstream and another side bitstream, which may be referred to as side channel information.

While shown in FIG. 2 as being directly transmitted to the content consumer device 14, the content creator device 12 may output the bitstream 21 to an intermediate device positioned between the content creator device 12 and the content consumer device 14. The intermediate device may store the bitstream 21 for later delivery to the content consumer device 14, which may request the bitstream. The intermediate device may comprise a file server, a web server, a desktop computer, a laptop computer, a tablet computer, a mobile phone, a smart phone, or any other device capable of storing the bitstream 21 for later retrieval by an audio decoder. The intermediate device may reside in a content delivery network capable of streaming the bitstream 21 (and possibly in conjunction with transmitting a corresponding video data bitstream) to subscribers, such as the content consumer device 14, requesting the bitstream 21.

Alternatively, the content creator device 12 may store the bitstream 21 to a storage medium, such as a compact disc, a digital video disc, a high definition video disc or other storage media, most of which are capable of being read by a computer and therefore may be referred to as computer-readable storage media or non-transitory computer-readable storage media. In this context, the transmission channel may refer to the channels by which content stored to the mediums are transmitted (and may include retail stores and other store-based delivery mechanism). In any event, the techniques of this disclosure should not therefore be limited in this respect to the example of FIG. 2.

As further shown in the example of FIG. 2, the content consumer device 14 includes the audio playback system 16. The audio playback system 16 may represent any audio playback system capable of playing back multi-channel audio data. The audio playback system 16 may include a number of different renderers 22. The renderers 22 may each provide for a different form of rendering, where the different forms of rendering may include one or more of the various ways of performing vector-base amplitude panning (VBAP), and/or one or more of the various ways of performing soundfield synthesis. As used herein, “A and/or B” means “A or B”, or both “A and B”.

The audio playback system 16 may further include an audio decoding device 24. The audio decoding device 24 may represent a device configured to decode HOA coefficients 11′ from the bitstream 21, where the HOA coefficients 11′ may be similar to the HOA coefficients 11 but differ due to lossy operations (e.g., quantization) and/or transmission via the transmission channel. The audio playback system 16 may, after decoding the bitstream 21 to obtain the HOA coefficients 11′ and render the HOA coefficients 11′ to output loudspeaker feeds 25. The loudspeaker feeds 25 may drive one or more loudspeakers (which are not shown in the example of FIG. 2 for ease of illustration purposes).

To select the appropriate renderer or, in some instances, generate an appropriate renderer, the audio playback system 16 may obtain loudspeaker information 13 indicative of a number of loudspeakers and/or a spatial geometry of the loudspeakers. In some instances, the audio playback system 16 may obtain the loudspeaker information 13 using a reference microphone and driving the loudspeakers in such a manner as to dynamically determine the loudspeaker information 13. In other instances or in conjunction with the dynamic determination of the loudspeaker information 13, the audio playback system 16 may prompt a user to interface with the audio playback system 16 and input the loudspeaker information 13.

The audio playback system 16 may then select one of the audio renderers 22 based on the loudspeaker information 13. In some instances, the audio playback system 16 may, when none of the audio renderers 22 are within some threshold similarity measure (in terms of the loudspeaker geometry) to the loudspeaker geometry specified in the loudspeaker information 13, generate the one of audio renderers 22 based on the loudspeaker information 13. The audio playback system 16 may, in some instances, generate one of the audio renderers 22 based on the loudspeaker information 13 without first attempting to select an existing one of the audio renderers 22.

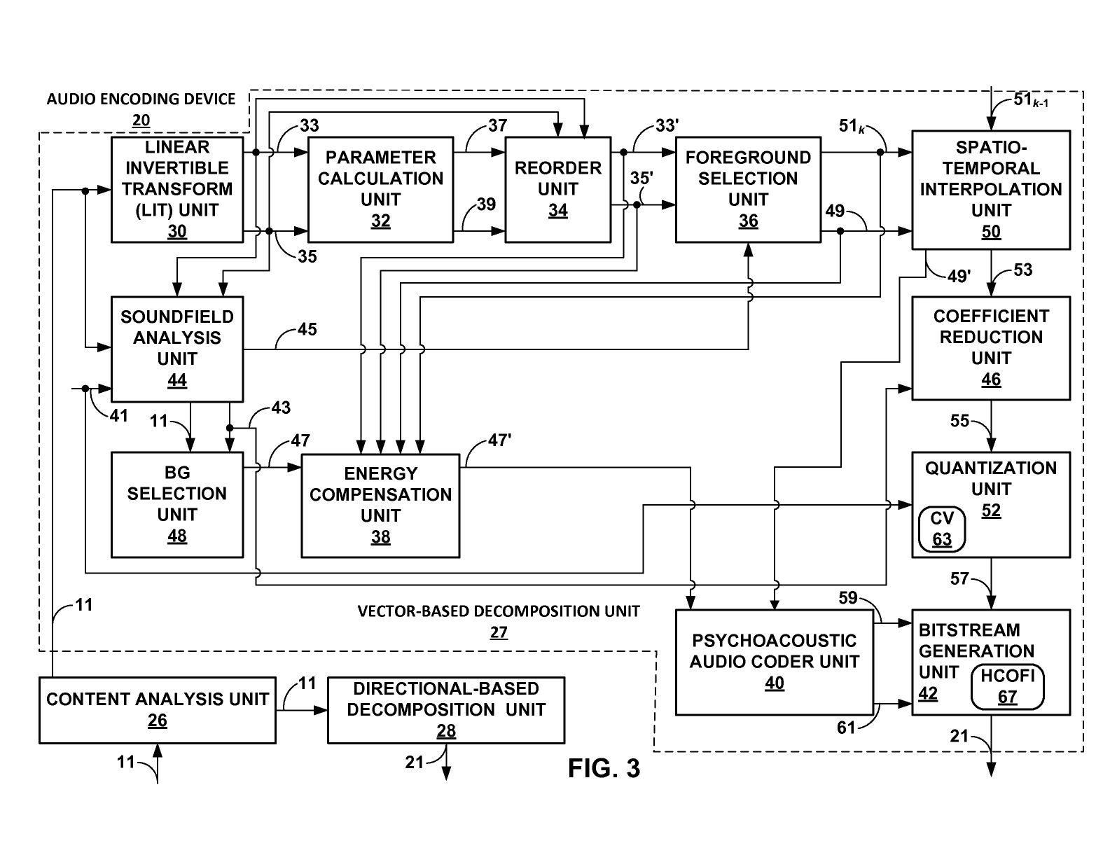

FIG. 3 is a block diagram illustrating, in more detail, one example of the audio encoding device 20 shown in the example of FIG. 2 that may perform various aspects of the techniques described in this disclosure. The audio encoding device 20 includes a content analysis unit 26, a vector-based decomposition unit 27 and a directional-based decomposition unit 28. Although described briefly below, more information regarding the audio encoding device 20 and the various aspects of compressing or otherwise encoding HOA coefficients is available in International Patent Application Publication No. WO 2014/194099, entitled “INTERPOLATION FOR DECOMPOSED REPRESENTATIONS OF A SOUND FIELD,” filed 29 May, 2014.

The content analysis unit 26 represents a unit configured to analyze the content of the HOA coefficients 11 to identify whether the HOA coefficients 11 represent content generated from a live recording or an audio object. The content analysis unit 26 may determine whether the HOA coefficients 11 were generated from a recording of an actual soundfield or from an artificial audio object. In some instances, when the framed HOA coefficients 11 were generated from a recording, the content analysis unit 26 passes the HOA coefficients 11 to the vector-based decomposition unit 27. In some instances, when the framed HOA coefficients 11 were generated from a synthetic audio object, the content analysis unit 26 passes the HOA coefficients 11 to the directional-based synthesis unit 28. The directional-based synthesis unit 28 may represent a unit configured to perform a directional-based synthesis of the HOA coefficients 11 to generate a directional-based bitstream 21.

As shown in the example of FIG. 3, the vector-based decomposition unit 27 may include a linear invertible transform (LIT) unit 30, a parameter calculation unit 32, a reorder unit 34, a foreground selection unit 36, an energy compensation unit 38, a psychoacoustic audio coder unit 40, a bitstream generation unit 42, a soundfield analysis unit 44, a coefficient reduction unit 46, a background (BG) selection unit 48, a spatio-temporal interpolation unit 50, and a quantization unit 52.

The linear invertible transform (LIT) unit 30 receives the HOA coefficients 11 in the form of HOA channels, each channel representative of a block or frame of a coefficient associated with a given order, sub-order of the spherical basis functions (which may be denoted as HOA[k], where k may denote the current frame or block of samples). The matrix of HOA coefficients 11 may have dimensions D: M×(N+1)².

The LIT unit 30 may represent a unit configured to perform a form of analysis referred to as singular value decomposition. While described with respect to SVD, the techniques described in this disclosure may be performed with respect to any similar transformation or decomposition that provides for sets of linearly uncorrelated, energy compacted output. Also, reference to “sets” in this disclosure is generally intended to refer to non-zero sets unless specifically stated to the contrary and is not intended to refer to the classical mathematical definition of sets that includes the so-called “empty set.” An alternative transformation may comprise a principal component analysis, which is often referred to as “PCA.” Depending on the context, PCA may be referred to by a number of different names, such as discrete Karhunen-Loeve transform, the Hotelling transform, proper orthogonal decomposition (POD), and eigenvalue decomposition (EVD) to name a few examples. Properties of such operations that are conducive to the underlying goal of compressing audio data are ‘energy compaction’ and ‘decorrelation’ of the multichannel audio data.

In any event, assuming the LIT unit 30 performs a singular value decomposition (which, again, may be referred to as “SVD”) for purposes of example, the LIT unit 30 may transform the HOA coefficients 11 into two or more sets of transformed HOA coefficients. The “sets” of transformed HOA coefficients may include vectors of transformed HOA coefficients. In the example of FIG. 3, the LIT unit 30 may perform the SVD with respect to the HOA coefficients 11 to generate a so-called V matrix, an S matrix, and a U matrix. SVD, in linear algebra, may represent a factorization of a y-by-z real or complex matrix X (where X may represent multi-channel audio data, such as the HOA coefficients 11) in the following form:

X=USV*

U may represent a y-by-y real or complex unitary matrix, where the y columns of U are known as the left-singular vectors of the multi-channel audio data. S may represent a y-by-z rectangular diagonal matrix with non-negative real numbers on the diagonal, where the diagonal values of S are known as the singular values of the multi-channel audio data. V* (which may denote a conjugate transpose of V) may represent a z-by-z real or complex unitary matrix, where the z columns of V* are known as the right-singular vectors of the multi-channel audio data.

In some examples, the V* matrix in the SVD mathematical expression referenced above is denoted as the conjugate transpose of the V matrix to reflect that SVD may be applied to matrices comprising complex numbers. When applied to matrices comprising only real-numbers, the complex conjugate of the V matrix (or, in other words, the V* matrix) may be considered to be the transpose of the V matrix. Below it is assumed, for ease of illustration purposes, that the HOA coefficients 11 comprise real-numbers with the result that the V matrix is output through SVD rather than the V* matrix. Moreover, while denoted as the V matrix in this disclosure, reference to the V matrix should be understood to refer to the transpose of the V matrix where appropriate. While assumed to be the V matrix, the techniques may be applied in a similar fashion to HOA coefficients 11 having complex coefficients, where the output of the SVD is the V* matrix. Accordingly, the techniques should not be limited in this respect to only provide for application of SVD to generate a V matrix, but may include application of SVD to HOA coefficients 11 having complex components to generate a V* matrix.

In this way, the LIT unit 30 may perform SVD with respect to the HOA coefficients 11 to output US[k] vectors 33 (which may represent a combined version of the S vectors and the U vectors) having dimensions D: M×(N+1)², and V[k] vectors 35 having dimensions D: (N+1)²×(N+1)². Individual vector elements in the US[k] matrix may also be termed X_{PS}(k) while individual vectors of the V[k] matrix may also be termed v(k).

An analysis of the U, S and V matrices may reveal that the matrices carry or represent spatial and temporal characteristics of the underlying soundfield represented above by X. Each of the N vectors in U (of length M samples) may represent normalized separated audio signals as a function of time (for the time period represented by M samples), that are orthogonal to each other and that have been decoupled from any spatial characteristics (which may also be referred to as directional information). The spatial characteristics, representing spatial shape and position (r, theta, phi) may instead be represented by individual i^{th} vectors, v⁽ⁱ⁾(k), in the V matrix (each of length (N+1)²). The individual elements of each of v⁽ⁱ⁾(k) vectors may represent an HOA coefficient describing the shape (including width) and position of the soundfield for an associated audio object. Both the vectors in the U matrix and the V matrix are normalized such that their root-mean-square energies are equal to unity. The energy of the audio signals in U are thus represented by the diagonal elements in S. Multiplying U and S to form US[k] (with individual vector elements X_{PS}(k)), thus represent the audio signal with energies. The ability of the SVD decomposition to decouple the audio time-signals (in U), their energies (in S) and their spatial characteristics (in V) may support various aspects of the techniques described in this disclosure. Further, the model of synthesizing the underlying HOA[k] coefficients, X, by a vector multiplication of US[k] and V[k] gives rise the term “vector-based decomposition,” which is used throughout this document.

Although described as being performed directly with respect to the HOA coefficients 11, the LIT unit 30 may apply the linear invertible transform to derivatives of the HOA coefficients 11. For example, the LIT unit 30 may apply SVD with respect to a power spectral density matrix derived from the HOA coefficients 11. By performing SVD with respect to the power spectral density (PSD) of the HOA coefficients rather than the coefficients themselves, the LIT unit 30 may potentially reduce the computational complexity of performing the SVD in terms of one or more of processor cycles and storage space, while achieving the same source audio encoding efficiency as if the SVD were applied directly to the HOA coefficients.

The parameter calculation unit 32 represents a unit configured to calculate various parameters, such as a correlation parameter (R), directional properties parameters (θ, φ, r), and an energy property (e). Each of the parameters for the current frame may be denoted as R[k], θ[k], φ[k], r[k] and e[k]. The parameter calculation unit 32 may perform an energy analysis and/or correlation (or so-called cross-correlation) with respect to the US[k] vectors 33 to identify the parameters. The parameter calculation unit 32 may also determine the parameters for the previous frame, where the previous frame parameters may be denoted R[k−1], θ[k−1], φ[k−1], r[k−1] and e[k−1], based on the previous frame of US[k−1] vector and V[k−1] vectors. The parameter calculation unit 32 may output the current parameters 37 and the previous parameters 39 to reorder unit 34.

The parameters calculated by the parameter calculation unit 32 may be used by the reorder unit 34 to re-order the audio objects to represent their natural evaluation or continuity over time. The reorder unit 34 may compare each of the parameters 37 from the first US[k] vectors 33 turn-wise against each of the parameters 39 for the second US[k−1] vectors 33. The reorder unit 34 may reorder (using, as one example, a Hungarian algorithm) the various vectors within the US[k] matrix 33 and the V[k] matrix 35 based on the current parameters 37 and the previous parameters 39 to output a reordered US[k] matrix 33′ (which may be denoted mathematically as ŪS[k]) and a reordered V[k] matrix 35′ (which may be denoted mathematically as V̅[k]) to a foreground sound (or predominant sound—PS) selection unit 36 (“foreground selection unit 36”) and an energy compensation unit 38.

The soundfield analysis unit 44 may represent a unit configured to perform a soundfield analysis with respect to the HOA coefficients 11 so as to potentially achieve a target bitrate 41. The soundfield analysis unit 44 may, based on the analysis and/or on a received target bitrate 41, determine the total number of psychoacoustic coder instantiations (which may be a function of the total number of ambient or background channels (BG_{TOT}) and the number of foreground channels or, in other words, predominant channels. The total number of psychoacoustic coder instantiations can be denoted as numHOATransportChannels.

The soundfield analysis unit 44 may also determine, again to potentially achieve the target bitrate 41, the total number of foreground channels (nFG) 45, the minimum order of the background (or, in other words, ambient) soundfield (N_{BG} or, alternatively, MinAmbHOAorder), the corresponding number of actual channels representative of the minimum order of background soundfield (nBGa=(MinAmbHOAorder+1)²), and indices (i) of additional BG HOA channels to send (which may collectively be denoted as background channel information 43 in the example of FIG. 3). The background channel information 42 may also be referred to as ambient channel information 43. Each of the channels that remains from numHOATransportChannels—nBGa, may either be an “additional background/ambient channel”, an “active vector-based predominant channel”, an “active directional based predominant signal” or “completely inactive”. In one aspect, the channel types may be indicated (as a “ChannelType”) syntax element by two bits (e.g. 00: directional based signal; 01: vector-based predominant signal; 10: additional ambient signal; 11: inactive signal). The total number of background or ambient signals, nBGa, may be given by (MinAmbHOAorder+1)²+the number of times the index 10 (in the above example) appears as a channel type in the bitstream for that frame.

The soundfield analysis unit 44 may select the number of background (or, in other words, ambient) channels and the number of foreground (or, in other words, predominant) channels based on the target bitrate 41, selecting more background and/or foreground channels when the target bitrate 41 is relatively higher (e.g., when the target bitrate 41 equals or is greater than 512 Kbps). In one aspect, the numHOATransportChannels may be set to 8 while the MinAmbHOAorder may be set to 1 in the header section of the bitstream. In this scenario, at every frame, four channels may be dedicated to represent the background or ambient portion of the soundfield while the other 4 channels can, on a frame-by-frame basis vary on the type of channel—e.g., either used as an additional background/ambient channel or a foreground/predominant channel. The foreground/predominant signals can be one of either vector-based or directional based signals, as described above.

In some instances, the total number of vector-based predominant signals for a frame, may be given by the number of times the ChannelType index is 01 in the bitstream of that frame. In the above aspect, for every additional background/ambient channel (e.g., corresponding to a ChannelType of 10), corresponding information of which of the possible HOA coefficients (beyond the first four) may be represented in that channel. The information, for fourth order HOA content, may be an index to indicate the HOA coefficients 5-25. The first four ambient HOA coefficients 1-4 may be sent all the time when minAmbHOAorder is set to 1, hence the audio encoding device may only need to indicate one of the additional ambient HOA coefficient having an index of 5-25. The information could thus be sent using a 5 bits syntax element (for 4^{th} order content), which may be denoted as “CodedAmbCoeffIdx.” In any event, the soundfield analysis unit 44 outputs the background channel information 43 and the HOA coefficients 11 to the background (BG) selection unit 36, the background channel information 43 to coefficient reduction unit 46 and the bitstream generation unit 42, and the nFG 45 to a foreground selection unit 36.

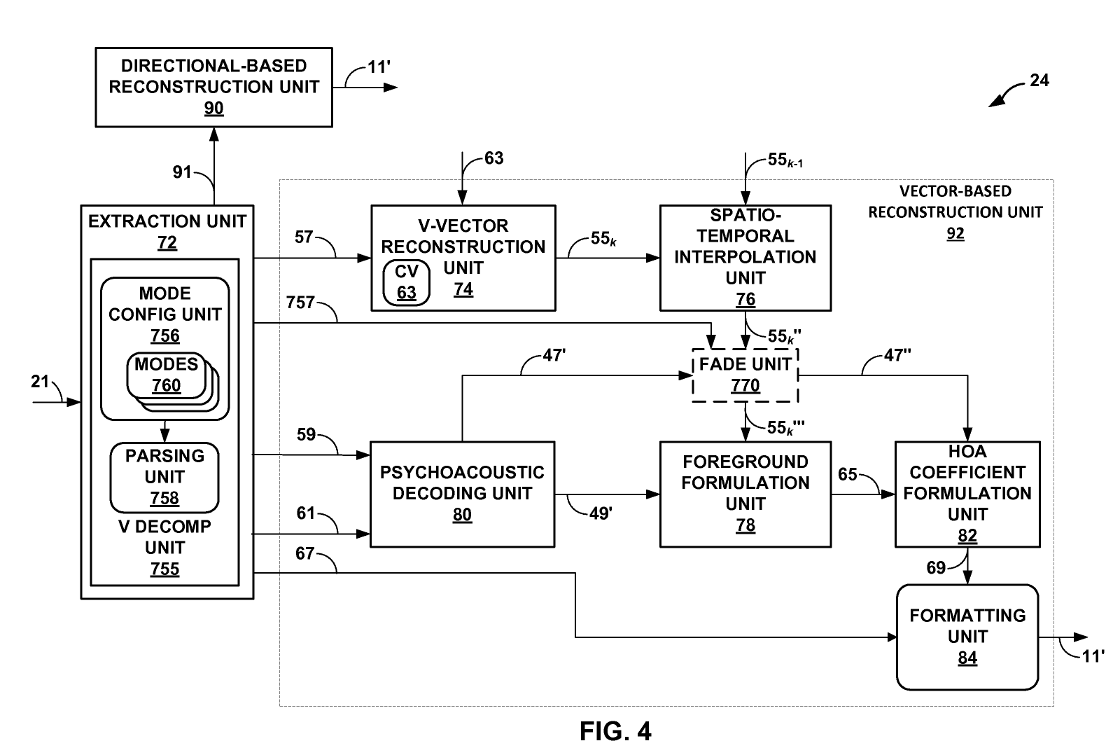

The background selection unit 48 may represent a unit configured to determine background or ambient HOA coefficients 47 based on the background channel information (e.g., the background soundfield (N_{BG}) and the number (nBGa) and the indices (i) of additional BG HOA channels to send). For example, when N_{BG} equals one, the background selection unit 48 may select the HOA coefficients 11 for each sample of the audio frame having an order equal to or less than one. The background selection unit 48 may, in this example, then select the HOA coefficients 11 having an index identified by one of the indices (i) as additional BG HOA coefficients, where the nBGa is provided to the bitstream generation unit 42 to be specified in the bitstream 21 so as to enable the audio decoding device, such as the audio decoding device 24 shown in the example of FIGS. 2 and 4, to parse the background HOA coefficients 47 from the bitstream 21. The background selection unit 48 may then output the ambient HOA coefficients 47 to the energy compensation unit 38. The ambient HOA coefficients 47 may have dimensions D: M×[(N_{BG}+1)²+nBGa]. The ambient HOA coefficients 47 may also be referred to as “ambient HOA coefficients 47,” where each of the ambient HOA coefficients 47 corresponds to a separate ambient HOA channel 47 to be encoded by the psychoacoustic audio coder unit 40.

The foreground selection unit 36 may represent a unit configured to select the reordered US[k] matrix 33′ and the reordered V[k] matrix 35′ that represent foreground or distinct components of the soundfield based on nFG 45 (which may represent a one or more indices identifying the foreground vectors). The foreground selection unit 36 may output nFG signals 49 (which may be denoted as a reordered US[k]_{1, . . . , nFG} 49, FG_{1, . . . , nfG}[k] 49, or X_{PS}^{(1 . . . nFG)}(k) 49) to the psychoacoustic audio coder unit 40, where the nFG signals 49 may have dimensions D: M×nFG and each represent mono-audio objects. The foreground selection unit 36 may also output the reordered V[k] matrix 35′ (or v^{(1 . . . nFG)}(k) 35′) corresponding to foreground components of the soundfield to the spatio-temporal interpolation unit 50, where a subset of the reordered V[k] matrix 35′ corresponding to the foreground components may be denoted as foreground V[k] matrix 51ₖ (which may be mathematically denoted as V̅_{1 . . . , nFG}[k]) having dimensions D: (N+1)²×nFG.

The energy compensation unit 38 may represent a unit configured to perform energy compensation with respect to the ambient HOA coefficients 47 to compensate for energy loss due to removal of various ones of the HOA channels by the background selection unit 48. The energy compensation unit 38 may perform an energy analysis with respect to one or more of the reordered US[k] matrix 33′, the reordered V[k] matrix 35′, the nFG signals 49, the foreground V[k] vectors 51ₖ and the ambient HOA coefficients 47 and then perform energy compensation based on the energy analysis to generate energy compensated ambient HOA coefficients 47′. The energy compensation unit 38 may output the energy compensated ambient HOA coefficients 47′ to the psychoacoustic audio coder unit 40.

The spatio-temporal interpolation unit 50 may represent a unit configured to receive the foreground V[k] vectors 51ₖ for the k^{th} frame and the foreground V[k−1] vectors 51ₖ₋₁ for the previous frame (hence the k−1 notation) and perform spatio-temporal interpolation to generate interpolated foreground V[k] vectors. The spatio-temporal interpolation unit 50 may recombine the nFG signals 49 with the foreground V[k] vectors 51ₖ to recover reordered foreground HOA coefficients. The spatio-temporal interpolation unit 50 may then divide the reordered foreground HOA coefficients by the interpolated V[k] vectors to generate interpolated nFG signals 49′. The spatio-temporal interpolation unit 50 may also output the foreground V[k] vectors 51ₖ that were used to generate the interpolated foreground V[k] vectors so that an audio decoding device, such as the audio decoding device 24, may generate the interpolated foreground V[k] vectors and thereby recover the foreground V[k] vectors 51ₖ. The foreground V[k] vectors 51ₖ used to generate the interpolated foreground V[k] vectors are denoted as the remaining foreground V[k] vectors 53. In order to ensure that the same V[k] and V[k−1] are used at the encoder and decoder (to create the interpolated vectors V[k]) quantized/dequantized versions of the vectors may be used at the encoder and decoder. The spatio-temporal interpolation unit 50 may output the interpolated nFG signals 49′ to the psychoacoustic audio coder unit 46 and the interpolated foreground V[k] vectors 51ₖ to the coefficient reduction unit 46.

The coefficient reduction unit 46 may represent a unit configured to perform coefficient reduction with respect to the remaining foreground V[k] vectors 53 based on the background channel information 43 to output reduced foreground V[k] vectors 55 to the quantization unit 52. The reduced foreground V[k] vectors 55 may have dimensions D: [(N+1)²−(N_{BG}+1)²−BG_{TOT}]×nFG. The coefficient reduction unit 46 may, in this respect, represent a unit configured to reduce the number of coefficients in the remaining foreground V[k] vectors 53. In other words, coefficient reduction unit 46 may represent a unit configured to eliminate the coefficients in the foreground V[k] vectors (that form the remaining foreground V[k] vectors 53) having little to no directional information. In some examples, the coefficients of the distinct or, in other words, foreground V[k] vectors corresponding to a first and zero order basis functions (which may be denoted as N_{BG}) provide little directional information and therefore can be removed from the foreground V-vectors (through a process that may be referred to as “coefficient reduction”). In this example, greater flexibility may be provided to not only identify the coefficients that correspond N_{BG} but to identify additional HOA channels (which may be denoted by the variable TotalOfAddAmbHOAChan) from the set of [(N_{BG}+1)²+1, (N+1)²].

The quantization unit 52 may represent a unit configured to perform any form of quantization to compress the reduced foreground V[k] vectors 55 to generate coded foreground V[k] vectors 57, outputting the coded foreground V[k] vectors 57 to the bitstream generation unit 42. In operation, the quantization unit 52 may represent a unit configured to compress a spatial component of the soundfield, i.e., one or more of the reduced foreground V[k] vectors 55 in this example. The quantization unit 52 may perform any one of the following 12 quantization modes, as indicated by a quantization mode syntax element denoted “NbitsQ”:

| NbitsQ value | Type of Quantization Mode |
|---|---|
| 0-3: | Reserved |
| 4: | Vector Quantization |
| 5: | Scalar Quantization without Huffman Coding |
| 6: | 6-bit Scalar Quantization with Huffman Coding |
| 7: | 7-bit Scalar Quantization with Huffman Coding |
| 8: | 8-bit Scalar Quantization with Huffman Coding |
| . . . | . . . |
| 16: | 16-bit Scalar Quantization with Huffman Coding |

The quantization unit 52 may also perform predicted versions of any of the foregoing types of quantization modes, where a difference is determined between an element of (or a weight when vector quantization is performed) of the V-vector of a previous frame and the element (or weight when vector quantization is performed) of the V-vector of a current frame is determined. The quantization unit 52 may then quantize the difference between the elements or weights of the current frame and previous frame rather than the value of the element of the V-vector of the current frame itself.

The quantization unit 52 may perform multiple forms of quantization with respect to each of the reduced foreground V[k] vectors 55 to obtain multiple coded versions of the reduced foreground V[k] vectors 55. The quantization unit 52 may select the one of the coded versions of the reduced foreground V[k] vectors 55 as the coded foreground V[k] vector 57. The quantization unit 52 may, in other words, select one of the non-predicted vector-quantized V-vector, predicted vector-quantized V-vector, the non-Huffman-coded scalar-quantized V-vector, and the Huffman-coded scalar-quantized V-vector to use as the output switched-quantized V-vector based on any combination of the criteria discussed in this disclosure. In some examples, the quantization unit 52 may select a quantization mode from a set of quantization modes that includes a vector quantization mode and one or more scalar quantization modes, and quantize an input V-vector based on (or according to) the selected mode. The quantization unit 52 may then provide the selected one of the non-predicted vector-quantized V-vector (e.g., in terms of weight values or bits indicative thereof), predicted vector-quantized V-vector (e.g., in terms of error values or bits indicative thereof), the non-Huffman-coded scalar-quantized V-vector and the Huffman-coded scalar-quantized V-vector to the bitstream generation unit 52 as the coded foreground V[k] vectors 57. The quantization unit 52 may also provide the syntax elements indicative of the quantization mode (e.g., the NbitsQ syntax element) and any other syntax elements used to dequantize or otherwise reconstruct the V-vector.

The quantization unit 52 may allocate bits to audio objects based on one or more singular values associated with the audio objects. For instance, in cases where the singular values for the background audio objects are sufficiently low (e.g., in amplitude) that the coded foreground V[k] vectors 57 and the encoded nFG signals 61 adequately represent or otherwise describe the signaled audio data, the bitstream generation unit 42 may allocate all of the available bits to the coded foreground V[k] vectors 57. For instance, the singular values for an audio object correspond to an energy of the audio object (e.g., by expressing the square root of the energy). In cases of small quantization errors for a large value in the V[k] and/or US[k] vectors for the background audio objects, the quantization error may be audible. Conversely, in cases of small quantization errors for a small value in the V[k] and/or US[k] vectors for the background audio objects, the quantization error may not be audible.

In turn, the quantization unit 52 may leverage these aspects of quantization error audibility to allocate bits to audio objects in a directly proportional manner to the strength (e.g., amplitude) of singular values associated with the audio objects. For instance, when an audio object is associated with a singular value of a lesser amplitude (e.g., below a threshold amplitude), the quantization unit 52 may allocate a lesser number of available bits (or even no bits) to the signaling of such an audio object. On the other hand, when an audio object is associated with a singular value of a greater amplitude (e.g., meeting or exceeding a threshold amplitude), the quantization unit 52 may allocate a greater number of available bits to the signaling of such an audio object.

In various examples, the received audio data (e.g., the coded foreground V[k] vectors 57, the encoded ambient HOA coefficients 59, and the encoded nFG signals 61) may include background audio objects having lesser-amplitude singular values and foreground audio objects having greater-amplitude singular values. In one such example, the quantization unit 52 may allocate all of the available bits to the foreground audio objects (e.g., as to be specified in the vector-based bitstream 21, and/or for signaling), and allocate no bits to the background audio objects (e.g., as to be specified in the bitstream 21, and/or for signaling). In another such example, the quantization unit 52 may allocate portions of the available bits to each of the foreground and background audio objects, in a manner that is proportional to the singular value amplitude of each respective singular value. In this manner, the quantization unit 52 may allocate bits in descending order of energy (e.g., importance). As described, the amplitude of a singular value describes a square root of the energy (and/or “eigenvalue”) of the associated audio object.

In some examples, the quantization unit 52 may set an upper limit (or “cap” or “maximum”) on the number of bits that can be allocated to a single audio object, with respect to being specified in the bitstream 21. By capping the number of bits that can be allocated to a single audio object, the quantization unit 52 may mitigate or eliminate potential inaccuracies arising from allocating all bits to signaling a small number of audio objects, which in turn may cause the absence of representations of other (potentially important/significant) audio objects from the vector-based bitstream 21.

In some examples, the quantization unit 52 may allocate the bits to the audio objects by applying a formula that is based on the amplitude of the singular value for each audio object. In one such example, the quantization unit 52 may allocate a percentage of the available bits according to an audio object, based on the amplitude of the singular value for the audio object. For instance, if a first foreground object has a singular value having an amplitude of 0.6, then the quantization unit 52 may allocate 60% of the available bits to the first foreground object. Additionally, if a second foreground object has a singular value having an amplitude of 0.3, then the quantization unit 52 may allocate 30% of the available bits to the second foreground object. In this example, if the remaining 10% are also allocated to the other foreground audio objects, the bitstream generation unit may not allocate any bits to any background audio objects. In this example, the quantization unit 52 may set the upper limit of bits for a single audio object at 60% or higher, thereby accommodating the 60% bit allocation to the first foreground object.

The psychoacoustic audio coder unit 40 included within the audio encoding device 20 may represent multiple instances of a psychoacoustic audio coder, each of which is used to encode a different audio object or HOA channel of each of the energy compensated ambient HOA coefficients 47′ and the interpolated nFG signals 49′ to generate encoded ambient HOA coefficients 59 and encoded nFG signals 61. The psychoacoustic audio coder unit 40 may output the encoded ambient HOA coefficients 59 and the encoded nFG signals 61 to the bitstream generation unit 42.

The bitstream generation unit 42 included within the audio encoding device 20 represents a unit that formats data to conform to a known format (which may refer to a format known by a decoding device), thereby generating the vector-based bitstream 21. The bitstream generation unit 42 may represent a multiplexer in some examples, which may receive the coded foreground V[k] vectors 57, the encoded ambient HOA coefficients 59, the encoded nFG signals 61, the background channel information 43, and the harmonic coefficient ordering format information (HCOFI) 67 (“HCOFI 67”). The bitstream generation unit 42 may then generate a bitstream 21 based on the coded foreground V[k] vectors 57, the encoded ambient HOA coefficients 59, the encoded nFG signals 61, the background channel information 43, and the harmonic coefficient ordering format information 67. The bitstream 21 may include a primary or main bitstream and one or more side channel bitstreams.

In other words, the bitstream generation unit 42 may be configured to operate in accordance with the techniques set forth in this disclosure to signal a harmonic coefficient ordering format that is used for encoding an HOA audio signal. For example the bitstream generation unit 42 may place a harmonic coefficient ordering format indicator into a coded bitstream 21 for an HOA audio signal. The harmonic coefficient ordering format indicator 67 may indicate according to which of a plurality of harmonic coefficient ordering formats a source set of harmonic coefficients 11 is formatted. Placing the harmonic coefficient ordering format indicator 67 into the bitstream 21 for an HOA audio signal may allow an audio decoder, such as the audio decoding device 24, to determine which harmonic coefficient ordering format was used for coding the source set of harmonic coefficients 11 that corresponds to a coded set of harmonic coefficients (which may, e.g., refer to any combination of the coded foreground V[k] vectors 57, the encoded ambient HOA coefficients 59, the encoded nFG signals 61, and the background channel information 43), and to appropriately decode the coded set of harmonic coefficients based on which harmonic coefficient ordering format was used. In this way, the audio decoding device 24 may be configurable to automatically detect and support multiple different types of harmonic coefficient ordering formats.

The bitstream generation unit 42 may be configured to generate a bitstream 21 based on the harmonic coefficients 11 and the harmonic coefficient ordering format information 67. For example, the audio encoding device 20 may code the harmonic coefficients 11 to generate a coded HOA audio signal (which may, e.g., refer to any combination of the coded foreground V[k] vectors 57, the encoded ambient HOA coefficients 59, the encoded nFG signals 61, and the background channel information 43), and generate the bitstream 21 such that the bitstream 21 includes the coded HOA audio signal and the harmonic coefficient ordering format indicator 67. The harmonic coefficient ordering format indicator 67 may indicate a harmonic coefficient ordering format for a source set of harmonic coefficients (e.g., the harmonic coefficients 11) that is used to generate the coded HOA audio signal.

In some examples, the audio encoding device 20 may be a three-dimensional (3D) HOA encoding device that is configured to encode spherical harmonic coefficients that represent a 3D soundfield. In further examples, the audio encoding device 20 may be a two-dimensional (2D) HOA encoding device that is configured to encode cylindrical harmonic coefficients that represent a 2D soundfield. In additional examples, the audio encoding device 20 may be configurable to operate in a 3D HOA encoding mode to encode spherical harmonic coefficients or in a 2D HOA encoding mode to encode cylindrical harmonic coefficients.

The harmonic coefficient ordering format information 67 includes information indicative of a harmonic coefficient ordering format for a set of harmonic coefficients (e.g., the harmonic coefficients 11). A harmonic coefficient ordering format may refer to an order in which harmonic coefficients occur in a set of harmonic coefficients. A set of harmonic coefficients may refer to any group of one or more harmonic coefficients. In some examples a set of harmonic coefficients may correspond to a frame or a sample of a frame of harmonic coefficients.

In some examples, the harmonic coefficient ordering format may specify an order in which harmonic coefficients occur in a matrix that is encoded by the audio encoding device 20. For example, the harmonic coefficient ordering format may specify an order in which harmonic coefficients occur in a matrix that is decomposed via the above described singular value decomposition when encoding the harmonic coefficients. In further examples, the harmonic coefficient ordering format may specify an ordering of harmonic coefficients that occurs in a set of decoded harmonic coefficients generated in response to decoding the coded HOA audio signal.

The harmonic coefficient ordering format information 67 may, in some examples, be included in metadata or side-channel information described elsewhere in this disclosure. Although the harmonic coefficient ordering format information 67 is illustrated as being separate from the harmonic coefficients 21, in other examples, the harmonic coefficient ordering format information 67 may be part of the harmonic coefficients 11.

In some examples, the bitstream generation unit 42 may obtain a source set of harmonic coefficients (e.g., the harmonic coefficients 11), determine a harmonic coefficient ordering format in which the source set of harmonic coefficients is formatted (e.g., based on the harmonic coefficient ordering format information 67). The bitstream generation unit 42 may further select a harmonic coefficient ordering format indicator value for the harmonic coefficient ordering format indicator 67 based on the determined harmonic coefficient ordering format, and generate the bitstream 21 such that the bitstream 21 includes the harmonic coefficient ordering format indicator value 67.

In some examples, the harmonic coefficient ordering format indicator 67 included in the bitstream 21 may be one or more bits included in the bitstream 21. In such examples, the bitstream 21 may, in some examples, include a coded HOA audio frame, and the one or more bits that correspond to the harmonic coefficient ordering format indicator 67 may be included in a header of the HOA audio frame. The coded HOA audio frame may include one or more coded harmonic coefficients corresponding to an HOA audio signal. In some cases, the coded HOA audio frame may be an access unit frame. In some examples, the harmonic coefficient ordering format indicator 67 may be one bit (i.e., a single bit). In further examples, the harmonic coefficient ordering format indicator 67 may be a plurality of bits (i.e., two or more bits).

In some examples, the bitstream 21 may include a plurality of coded HOA audio frames. In such examples, the bitstream generation unit 42 may, in some examples, generate the bitstream 21 such that each of the coded HOA audio frames includes a harmonic coefficient ordering format indicator 67 that indicates a harmonic coefficient ordering format for a respective source set of harmonic coefficients 11 that is used to generate the respective coded HOA audio frame.

In further examples where the bitstream 21 includes a plurality of coded HOA audio frames, the bitstream generation unit 42 may, in some examples, generate the bitstream 21 such that every Yth coded HOA audio frame includes a harmonic coefficient ordering format indicator 67 that indicates a harmonic coefficient ordering format for a respective source set of harmonic coefficients 11 that is used to generate one or more coded HOA audio frames, and such that coded HOA audio frames between every Yth coded HOA audio frame do not include the harmonic coefficient ordering format indicator 67. Y may represent an integer greater than or equal to two.

In additional examples where the bitstream 21 includes a plurality of coded HOA audio frames, the plurality of coded HOA audio frames may include one or more access unit frames and a plurality of non-access unit frames. In such examples, the bitstream generation unit 42 may, in some examples, generate the bitstream 21 such that each of the access unit frames includes a harmonic coefficient ordering format indicator 67 that indicates a harmonic coefficient ordering format for a respective source set of harmonic coefficients 11 that is used to generate one or more of the coded HOA audio frames, and such that each of the non-access unit frames does not include the harmonic coefficient ordering format indicator 67.

In further examples, the harmonic coefficient ordering format indicator may indicate according to which of a plurality of candidate harmonic coefficient ordering formats the source set of harmonic coefficients 11 is formatted. In these and other examples, the harmonic coefficient ordering format indicator may be indicative of whether the source set of harmonic coefficients 11 is formatted according to a linear harmonic coefficient ordering format or a symmetric harmonic coefficient ordering format.

The linear harmonic coefficient ordering format and the symmetric harmonic coefficient ordering format will now be described in further detail with respect to Tables 5-8. In particular, the linear harmonic coefficient ordering format and the symmetric harmonic coefficient ordering format for spherical harmonic coefficients associated with a 3D soundfield will be described in further detail below with respect to Tables 5 and 6:

TABLE 5
Linear harmonic coefficient ordering format for spherical
harmonic coefficients associated with a 3D soundfield.

| Linear | Spherical |
|---|---|
| Ordering | Harmonic |
| Index | Coefficient (n, m) |
| 0 | (0, 0) |
| 1 | (1, −1) |
| 2 | (1, 0) |
| 3 | (1, 1) |
| 4 | (2, −2) |
| 5 | (2, −1) |
| 6 | (2, 0) |
| 7 | (2, 1) |
| 8 | (2, 2) |
| 9 | (3, −3) |
| 10 | (3, −2) |
| 11 | (3, −1) |
| 12 | (3, 0) |
| 13 | (3, 1) |
| 14 | (3, 2) |
| 15 | (3, 3) |
| 16 | (4, −4) |
| 17 | (4, −3) |
| 18 | (4, −2) |
| 19 | (4, −1) |
| 20 | (4, 0) |
| 21 | (4, 1) |
| 22 | (4, 2) |
| 23 | (4, 3) |
| 24 | (4, 4) |
| 25 | (5, −5) |
| 26 | (5, −4) |
| 27 | (5, −3) |
| 28 | (5, −2) |
| 29 | (5, −1) |
| 30 | (5, 0) |
| 31 | (5, 1) |
| 32 | (5, 2) |
| 33 | (5, 3) |
| 34 | (5, 4) |
| 35 | (5, 5) |
| 36 | (6, −6) |
| 37 | (6, −5) |
| 38 | (6, −4) |
| 39 | (6, −3) |
| 40 | (6, −2) |
| 41 | (6, −1) |
| 42 | (6, 0) |
| 43 | (6, 1) |
| 44 | (6, 2) |
| 45 | (6, 3) |
| 46 | (6, 4) |
| 47 | (6, 5) |
| 48 | (6, 6) |
| 49 | (7, −7) |
| 50 | (7, −6) |
| 51 | (7, −5) |
| 52 | (7, −4) |
| 53 | (7, −3) |
| 54 | (7, −2) |
| 55 | (7, −1) |
| 56 | (7, 0) |
| 57 | (7, 1) |
| 58 | (7, 2) |
| 59 | (7, 3) |
| 60 | (7, 4) |
| 61 | (7, 5) |
| 62 | (7, 6) |
| 63 | (7, 7) |
| 64 | (8, −8) |
| 65 | (8, −7) |
| 66 | (8, −6) |
| 67 | (8, −5) |
| 68 | (8, −4) |
| 69 | (8, −3) |
| 70 | (8, −2) |
| 71 | (8, −1) |
| 72 | (8, 0) |
| 73 | (8, 1) |
| 74 | (8, 2) |
| 75 | (8, 3) |
| 76 | (8, 4) |
| 77 | (8, 5) |
| 78 | (8, 6) |
| 79 | (8, 7) |
| 80 | (8, 8) |
| 81 | (9, −9) |
| 82 | (9, −8) |
| 83 | (9, −7) |
| 84 | (9, −6) |
| 85 | (9, −5) |
| 86 | (9, −4) |
| 87 | (9, −3) |
| 88 | (9, −2) |
| 89 | (9, −1) |
| 90 | (9, 0) |
| 91 | (9, 1) |
| 92 | (9, 2) |
| 93 | (9, 3) |
| 94 | (9, 4) |
| 95 | (9, 5) |
| 96 | (9, 6) |
| 97 | (9, 7) |
| 98 | (9, 8) |
| 99 | (9, 9) |

TABLE 6
Symmetric harmonic coefficient ordering format for spherical
harmonic coefficients associated with a 3D soundfield.

| Symmetric | Spherical |
|---|---|
| Ordering | Harmonic |
| Index | Coefficient (n, m) |
| 0 | (0, 0) |
| 1 | (1, 1) |
| 2 | (1, −1) |
| 3 | (1, 0) |
| 4 | (2, 2) |
| 5 | (2, −2) |
| 6 | (2, 1) |
| 7 | (2, −1) |
| 8 | (2, 0) |
| 9 | (3, 3) |
| 10 | (3, −3) |
| 11 | (3, 2) |
| 12 | (3, −2) |
| 13 | (3, 1) |
| 14 | (3, −1) |
| 15 | (3, 0) |
| 16 | (4, 4) |
| 17 | (4, −4) |
| 18 | (4, 3) |
| 19 | (4, −3) |
| 20 | (4, 2) |
| 21 | (4, −2) |
| 22 | (4, 1) |
| 23 | (4, −1) |
| 24 | (4, 0) |
| 25 | (5, 5) |
| 26 | (5, −5) |
| 27 | (5, 4) |
| 28 | (5, −4) |
| 29 | (5, 3) |
| 30 | (5, −3) |
| 31 | (5, 2) |
| 32 | (5, −2) |
| 33 | (5, 1) |
| 34 | (5, −1) |
| 35 | (5, 0) |
| 36 | (6, 6) |
| 37 | (6, −6) |
| 38 | (6, 5) |
| 39 | (6, −5) |
| 40 | (6, 4) |
| 41 | (6, −4) |
| 42 | (6, 3) |
| 43 | (6, −3) |
| 44 | (6, 2) |
| 45 | (6, −2) |
| 46 | (6, 1) |
| 47 | (6, −1) |
| 48 | (6, 0) |
| 49 | (7, 7) |
| 50 | (7, −7) |
| 51 | (7, 6) |
| 52 | (7, −6) |
| 53 | (7, 5) |
| 54 | (7, −5) |
| 55 | (7, 4) |
| 56 | (7, −4) |
| 57 | (7, 3) |
| 58 | (7, −3) |
| 59 | (7, 2) |
| 60 | (7, −2) |
| 61 | (7, 1) |
| 62 | (7, −1) |
| 63 | (7, 0) |
| 64 | (8, 8) |
| 65 | (8, −8) |
| 66 | (8, 7) |
| 67 | (8, −7) |
| 68 | (8, 6) |
| 69 | (8, −6) |
| 70 | (8, 5) |
| 71 | (8, −5) |
| 72 | (8, 4) |
| 73 | (8, −4) |
| 74 | (8, 3) |
| 75 | (8, −3) |
| 76 | (8, 2) |
| 77 | (8, −2) |
| 78 | (8, 1) |
| 79 | (8, −1) |
| 80 | (8, 0) |
| 81 | (9, 9) |
| 82 | (9, −9) |
| 83 | (9, 8) |
| 84 | (9, −8) |
| 85 | (9, 7) |
| 86 | (9, −7) |
| 87 | (9, 6) |
| 88 | (9, −6) |
| 89 | (9, 5) |
| 90 | (9, −5) |
| 91 | (9, 4) |
| 92 | (9, −4) |
| 93 | (9, 3) |
| 94 | (9, −3) |
| 95 | (9, 2) |
| 96 | (9, −2) |
| 97 | (9, 1) |
| 98 | (9, −1) |
| 99 | (9, 0) |

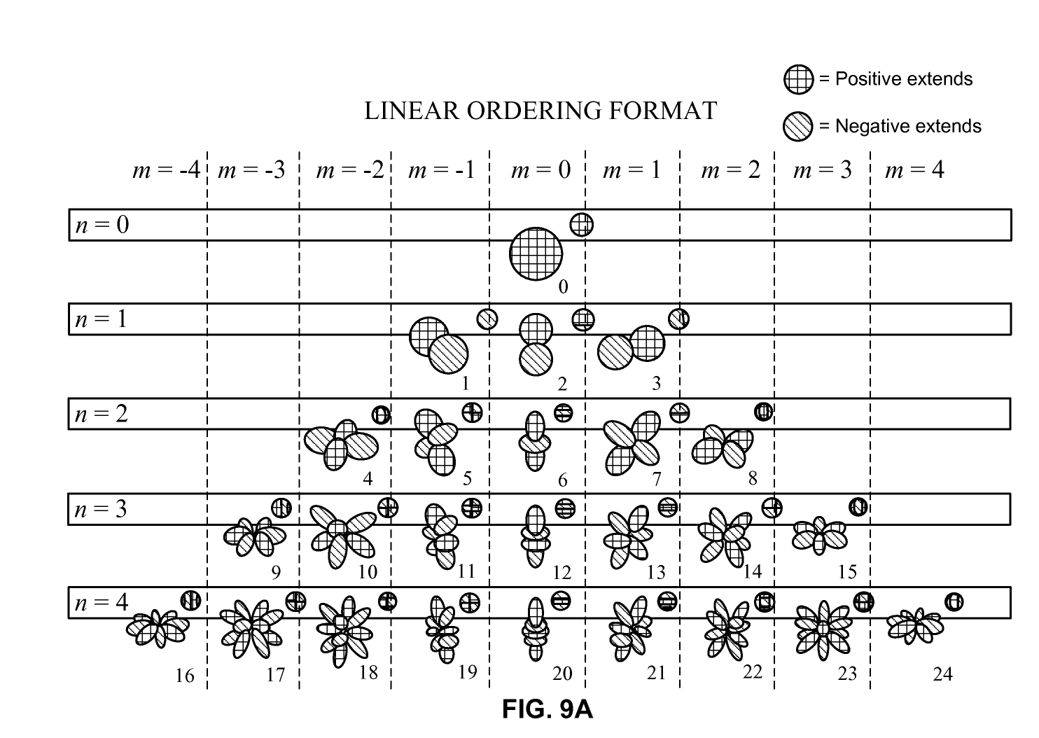

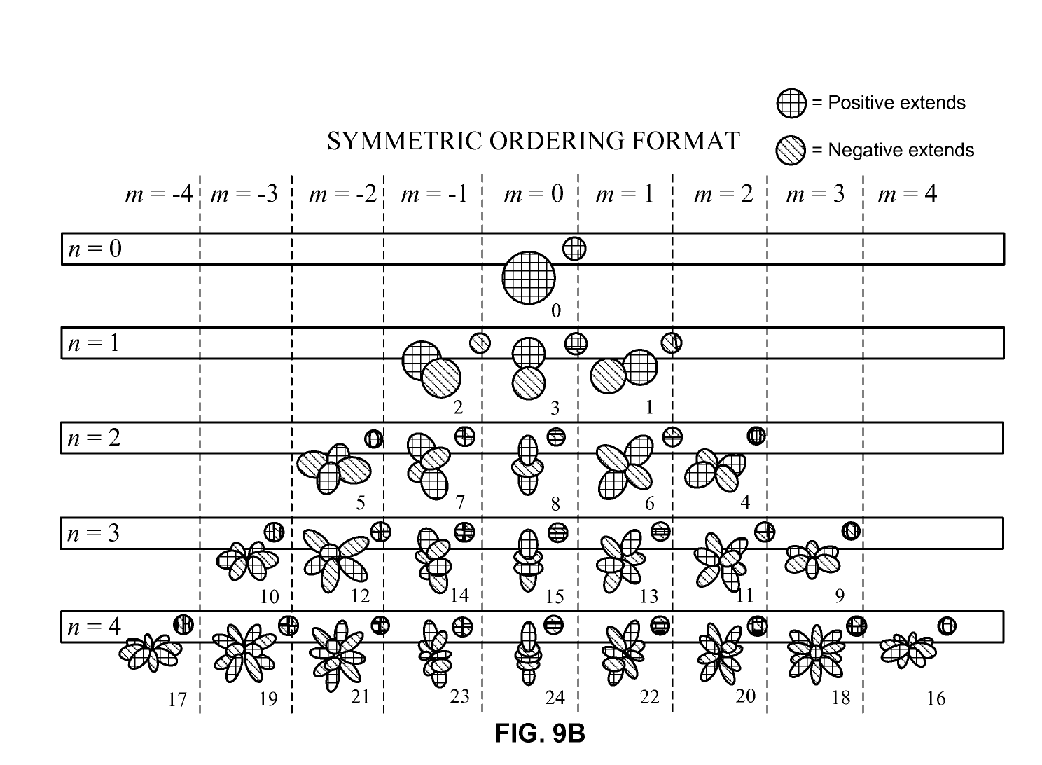

Table 5 illustrates a linear ordering format that may be used to format a set of spherical harmonic coefficients that includes the first ten orders (i.e., orders zero through nine) of spherical harmonic coefficients. The left-hand column of Table 5 specifies linear ordering indices, and the right-hand column of Table 5 specifies spherical harmonic coefficients. Each of the spherical harmonic coefficients may be associated with a respective spherical harmonic basis function having a respective order (n) and a respective sub-order (m). Each of the rows of Table 5 maps a spherical harmonic coefficient having order n and sub-order m to a respective linear ordering index. The linear ordering indices define the order of the spherical harmonic coefficients increasing from 0 to 99 in this example. FIG. 9A is a diagram illustrating the linear ordering format for five orders (i.e., zero through four), showing the spherical basis functions and the respective index in the lower right corner for each order (n) and sub-order (m).

Table 6 illustrates a symmetric ordering format that may be used to format a set of spherical harmonic coefficients that includes the first ten orders (i.e., orders zero through nine) of spherical harmonic coefficients. The left-hand column of Table 6 specifies symmetric ordering indices, and the right-hand column of Table 6 specifies spherical harmonic coefficients. Each of the rows of Table 6 maps a spherical harmonic coefficient having order n and sub-order m to a respective symmetric ordering index. The symmetric ordering indices define the order of the spherical harmonic coefficients increasing from 0 to 99 in this example. FIG. 9B is a diagram illustrating the symmetric ordering format for five orders (i.e., zero through four), showing the spherical basis functions and the respective index in the lower right corner for each order (n) and sub-order (m).

As shown in Table 5, the linear harmonic coefficient ordering format for spherical harmonic coefficients specifies a sequence of spherical harmonic coefficients in which a linear ordering index for the spherical harmonic coefficients increases from start to end of the sequence. In some examples, the linear ordering index may be defined based on the following equation/mapping:

a_{n,m}=n²n+m (1)

where a_{n,m} is the linear ordering index associated with a spherical harmonic coefficient of order n and sub-order m.

As shown in Table 6, the symmetric harmonic coefficient ordering format for spherical harmonic coefficients specifies a sequence of spherical harmonic coefficients in which a symmetric ordering index for the spherical harmonic coefficients increases from start to end of the sequence. In some examples, the symmetric ordering index may be defined based on the following equation/mapping:

$${b}_{n , m} = \{ \begin{matrix}{n}^{2} + 2 n - 2 m , & m \geq 0 \\ {n}^{2} + 2 n + 2 m + 1 , & m < 0\end{matrix} \qquad ( 2 )$$

where b_{n,m} is the symmetric ordering index associated with a spherical harmonic coefficient of order n and sub-order m.

As shown in Table 5, the linear harmonic coefficient ordering format for spherical harmonic coefficients specifies a sequence of spherical harmonic coefficients in which the orders corresponding to the spherical harmonic coefficients monotonically increase from start to end of the sequence, and the sub-orders corresponding to spherical harmonic coefficients that have the same order increase from start to end of a sub-sequence formed by the spherical harmonic coefficients that have the same order.

As shown in Table 6, the symmetric harmonic coefficient ordering format for cylindrical harmonic coefficients specifies a sequence of spherical harmonic coefficients in which the orders corresponding to the spherical harmonic coefficients monotonically increase from start to end of the sequence, the magnitudes of the sub-orders corresponding to spherical harmonic coefficients that have the same order monotonically decrease from start to end of a sub-sequence formed by the spherical harmonic coefficients that have the same order, and for sub-orders of equal magnitude, positive sub-orders occur prior to negative sub-orders.

As shown in Table 5, the linear harmonic coefficient ordering format for spherical harmonic coefficients specifies a sequence of spherical harmonic coefficients in which spherical harmonic coefficients with lower orders occur prior to spherical harmonic coefficients with higher orders, and for each order, spherical harmonic coefficients with lower sub-orders occur prior to spherical harmonic coefficients with higher sub-orders.

As shown in Table 6, the symmetric harmonic coefficient ordering format for spherical harmonic coefficients specifies a sequence of spherical harmonic coefficients in which spherical harmonic coefficients with lower orders occur prior to spherical harmonic coefficients with higher orders, and for each order, spherical harmonic coefficients with higher sub-order magnitudes occur prior to spherical harmonic coefficients with lower sub-order magnitudes, and for sub-orders of equal magnitude, positive sub-orders occur prior to negative sub-orders.

As shown in Table 5, the linear harmonic coefficient ordering format for spherical harmonic coefficients specifies a sequence of spherical harmonic coefficients in which spherical harmonic coefficient with symmetric sub-orders are not adjacent to each other. As shown in Table 6, the symmetric harmonic coefficient ordering format specifies a sequence of spherical harmonic coefficients in which spherical harmonic coefficient with symmetric sub-orders are adjacent to each other.

The linear harmonic coefficient ordering format and the symmetric harmonic coefficient ordering format for cylindrical harmonic coefficients associated with a 2D soundfield will be described in further detail below with respect to Tables 7 and 8:

TABLE 7
Linear cylindrical harmonic coefficient ordering format for cylindrical
harmonic coefficients associated with a 2D soundfield.

| Linear | Cylindrical |
|---|---|
| Ordering | Harmonic |
| Index | Coefficient (n, m) |
| 0 | (0, 0) |
| 1 | (1, −1) |
| 2 | (1, 1) |
| 3 | (2, −2) |
| 4 | (2, 2) |
| 5 | (3, −3) |
| 6 | (3, 3) |

TABLE 8
Symmetric cylindrical harmonic coefficient
ordering format for cylindrical harmonic coefficients
associated with a 2D soundfield.

| Symmetric | Cylindrical |
|---|---|
| Ordering | Harmonic |
| Index | Coefficient (n, m) |
| 0 | (0, 0) |
| 1 | (1, 1) |
| 2 | (1, −1) |
| 3 | (2, 2) |
| 4 | (2, −2) |
| 5 | (3, 3) |
| 6 | (3, −3) |

Table 7 illustrates a linear ordering format that may be used to format a set of cylindrical harmonic coefficients that includes the first four orders (i.e., orders zero through three) of cylindrical harmonic coefficients. The left-hand column of Table 7 specifies linear ordering indices, and the right-hand column of Table 7 specifies cylindrical harmonic coefficients. Each of the cylindrical harmonic coefficients may be associated with a respective cylindrical harmonic basis function having a respective order (n) and a respective sub-order (m). Each of the rows of Table 7 maps a cylindrical harmonic coefficient having order n and sub-order m to a respective linear ordering index. The linear ordering indices define the order of the cylindrical harmonic coefficients increasing from 0 to 6 in this example.

Table 8 illustrates a symmetric ordering format that may be used to format a set of cylindrical harmonic coefficients that includes the first four orders (i.e., orders zero through three) of cylindrical harmonic coefficients. The left-hand column of Table 8 specifies symmetric ordering indices, and the right-hand column of Table 8 specifies cylindrical harmonic coefficients. Each of the rows of Table 8 maps a cylindrical harmonic coefficient having order n and sub-order m to a respective symmetric ordering index. The symmetric ordering indices define the order of the cylindrical harmonic coefficients increasing from 0 to 6 in this example.

As shown in Table 7, the linear cylindrical harmonic coefficient ordering format specifies a sequence of cylindrical harmonic coefficients in which a linear ordering index for the cylindrical harmonic coefficients increases from start to end of the sequence. In some examples, the linear ordering index may be defined based on the following equation/mapping:

$${c}_{n , m} = \{ \begin{matrix}2 n , & m \geq 0 \\ 2 n - 1 , & m < 0\end{matrix} \qquad ( 3 )$$

where c_{n,m} is the linear ordering index associated with a cylindrical harmonic coefficient of order n and sub-order m.

As shown in Table 8, the symmetric cylindrical harmonic coefficient ordering format specifies a sequence of cylindrical harmonic coefficients in which a symmetric ordering index for the cylindrical harmonic coefficients increases from start to end of the sequence. In some examples, the symmetric ordering index may be defined based on the following equation/mapping:

$${d}_{n , m} = \{ \begin{matrix}2 n - 1 , & m > 0 \\ 2 n , & m \leq 0\end{matrix} \qquad ( 4 )$$

where d_{n,m} is the symmetric ordering index associated with a cylindrical harmonic coefficient of order n and sub-order m.

In examples where the harmonic coefficients 11 are spherical harmonic coefficients, the coded harmonic coefficients may be referred to as coded spherical harmonic coefficients. In some examples, the harmonic coefficient ordering formats may include spherical harmonic coefficient formats that define an order in which spherical harmonic coefficients occur in a set of spherical harmonic coefficients. In further examples, the harmonic coefficient ordering format indicator may be a spherical harmonic coefficient ordering format indicator that indicates according to which of a plurality of candidate spherical harmonic coefficient ordering formats the source set of spherical harmonic coefficients is formatted. In some examples, the spherical harmonic coefficient ordering format indicator may indicate whether the source set of spherical harmonic coefficients is formatted according to a linear spherical harmonic coefficient ordering format or a symmetric spherical harmonic coefficient ordering format.

In examples where the harmonic coefficients 11 are cylindrical harmonic coefficients, the coded harmonic coefficients may be referred to as coded cylindrical harmonic coefficients. In some examples, the harmonic coefficient ordering formats may include cylindrical harmonic coefficient formats that define an order in which cylindrical harmonic coefficients occur in a set of cylindrical harmonic coefficients. In further examples, the harmonic coefficient ordering format indicator may be a cylindrical harmonic coefficient ordering format indicator that indicates according to which of a plurality of candidate cylindrical harmonic coefficient ordering formats the source set of cylindrical harmonic coefficients is formatted. In some examples, the cylindrical harmonic coefficient ordering format indicator may indicate whether the source set of cylindrical harmonic coefficients is formatted according to a linear cylindrical harmonic coefficient ordering format or a symmetric cylindrical harmonic coefficient ordering format.

In general, the linear harmonic coefficient ordering format may refer to a linear spherical harmonic coefficient format or a linear cylindrical harmonic coefficient format. The symmetric harmonic coefficient ordering format may refer to a symmetric spherical harmonic coefficient format or a symmetric cylindrical harmonic coefficient format.

In some examples, the harmonic coefficient ordering format indicator may indicate whether the source set of harmonic coefficients is formatted according to a linear spherical harmonic coefficient ordering format, a linear cylindrical harmonic coefficient ordering format, a symmetric spherical harmonic coefficient ordering format, or a symmetric cylindrical harmonic coefficient ordering format.

In further examples, in addition to or in lieu of indicating the harmonic coefficient ordering format for a source set of harmonic coefficients, the harmonic coefficient ordering format indicator may indicate a dimensionality of a soundfield represented by the source set of harmonic coefficients. For example, the harmonic coefficient ordering format indicator may indicate whether the source set of harmonic coefficients are spherical harmonic coefficients or cylindrical harmonic coefficients. As another example, the harmonic coefficient ordering format indicator may indicate whether the source set of coefficients are 2D HOA coefficients or 3D HOA coefficients.

In some examples, the bitstream generation unit 42 may generate the bitstream 21 to include a soundfield dimensionality indicator that indicates a dimensionality of the soundfield represented by the source set of harmonic coefficients. For example, the soundfield dimensionality indicator may indicate whether the source set of harmonic coefficients represent a 2D soundfield or a 3D sound field. As another example, the soundfield dimensionality indicator may indicate whether the source set of harmonic coefficients are spherical harmonic coefficients or cylindrical harmonic coefficients.

In some examples, the bitstream generation unit 42 may generate the bitstream 21 to include both a harmonic coefficient ordering format indicator 67 and a soundfield dimensionality indicator. In further examples, the bitstream generation unit 42 may generate the bitstream 21 to include a harmonic coefficient ordering format indicator 67 and to not include a soundfield dimensionality indicator. In additional examples, the bitstream generation unit 42 may generate the bitstream 21 to include a soundfield dimensionality indicator 67 and to not include a harmonic coefficient ordering format indicator.

Although not shown in the example of FIG. 3, the audio encoding device 20 may also include a bitstream output unit that switches the bitstream output from the audio encoding device 20 (e.g., between the directional-based bitstream 21 and the vector-based bitstream 21) based on whether a current frame is to be encoded using the directional-based synthesis or the vector-based synthesis. The bitstream output unit may perform the switch based on the syntax element output by the content analysis unit 26 indicating whether a directional-based synthesis was performed (as a result of detecting that the HOA coefficients 11 were generated from a synthetic audio object) or a vector-based synthesis was performed (as a result of detecting that the HOA coefficients were recorded). The bitstream output unit may specify the correct header syntax to indicate the switch or current encoding used for the current frame along with the respective one of the bitstreams 21.

Moreover, as noted above, the soundfield analysis unit 44 may identify BG_{TOT} ambient HOA coefficients 47, which may change on a frame-by-frame basis (although at times BG_{TOT} may remain constant or the same across two or more adjacent (in time) frames). The change in BG_{TOT} may result in changes to the coefficients expressed in the reduced foreground V[k] vectors 55. The change in BG_{TOT} may result in background HOA coefficients (which may also be referred to as “ambient HOA coefficients”) that change on a frame-by-frame basis (although, again, at times BG_{TOT} may remain constant or the same across two or more adjacent (in time) frames). The changes often result in a change of energy for the aspects of the sound field represented by the addition or removal of the additional ambient HOA coefficients and the corresponding removal of coefficients from or addition of coefficients to the reduced foreground V[k] vectors 55.

As a result, the soundfield analysis unit 44 may further determine when the ambient HOA coefficients change from frame to frame and generate a flag or other syntax element indicative of the change to the ambient HOA coefficient in terms of being used to represent the ambient components of the sound field (where the change may also be referred to as a “transition” of the ambient HOA coefficient or as a “transition” of the ambient HOA coefficient). In particular, the coefficient reduction unit 46 may generate the flag (which may be denoted as an AmbCoeffTransition flag or an AmbCoeffIdxTransition flag), providing the flag to the bitstream generation unit 42 so that the flag may be included in the bitstream 21 (possibly as part of side channel information).

The coefficient reduction unit 46 may, in addition to specifying the ambient coefficient transition flag, also modify how the reduced foreground V[k] vectors 55 are generated. In one example, upon determining that one of the ambient HOA ambient coefficients is in transition during the current frame, the coefficient reduction unit 46 may specify, a vector coefficient (which may also be referred to as a “vector element” or “element”) for each of the V-vectors of the reduced foreground V[k] vectors 55 that corresponds to the ambient HOA coefficient in transition. Again, the ambient HOA coefficient in transition may add or remove from the BG_{TOT} total number of background coefficients. Therefore, the resulting change in the total number of background coefficients affects whether the ambient HOA coefficient is included or not included in the bitstream, and whether the corresponding element of the V-vectors are included for the V-vectors specified in the bitstream in the second and third configuration modes described above. More information regarding how the coefficient reduction unit 46 may specify the reduced foreground V[k] vectors 55 to overcome the changes in energy is provided in U.S. application Ser. No. 14/594,533, entitled “TRANSITIONING OF AMBIENT HIGHER_ORDER AMBISONIC COEFFICIENTS,” filed Jan. 12, 2015.

FIG. 4 is a block diagram illustrating the audio decoding device 24 of FIG. 2 in more detail. The audio decoding device 24 may be a three-dimensional (3D) HOA decoding device that is configured to decode coded spherical harmonic coefficients that represent a 3D soundfield. In further examples, the audio decoding device 24 may be a two-dimensional (2D) HOA decoding device that is configured to decode coded cylindrical harmonic coefficients that represent a 2D soundfield. In additional examples, the audio decoding device 24 may be configurable to operate in a 3D HOA decoding mode to decode coded spherical harmonic coefficients or in a 2D HOA decoding mode to decode cylindrical harmonic coefficients.

As shown in the example of FIG. 4 the audio decoding device 24 may include an extraction unit 72, a directionality-based reconstruction unit 90 and a vector-based reconstruction unit 92. Although described below, more information regarding the audio decoding device 24 and the various aspects of decompressing or otherwise decoding HOA coefficients is available in International Patent Application Publication No. WO 2014/194099, entitled “INTERPOLATION FOR DECOMPOSED REPRESENTATIONS OF A SOUND FIELD,” filed 29 May, 2014.

The extraction unit 72 may represent a unit configured to receive the bitstream 21 and extract the various encoded versions (e.g., a directional-based encoded version or a vector-based encoded version) of the HOA coefficients 11. The extraction unit 72 may determine from the above noted syntax element indicative of whether the HOA coefficients 11 were encoded via the various direction-based or vector-based versions. When a directional-based encoding was performed, the extraction unit 72 may extract the directional-based version of the HOA coefficients 11 and the syntax elements associated with the encoded version (which is denoted as directional-based information 91 in the example of FIG. 4), passing the directional based information 91 to the directional-based reconstruction unit 90. The directional-based reconstruction unit 90 may represent a unit configured to reconstruct the HOA coefficients in the form of HOA coefficients 11′ based on the directional-based information 91.

When the syntax element indicates that the HOA coefficients 11 were encoded using a vector-based synthesis, the extraction unit 72 may extract the coded foreground V[k] vectors 57 (which may include coded weights 57 and/or indices 63 or scalar quantized V-vectors), the encoded ambient HOA coefficients 59 and the corresponding audio objects 61 (which may also be referred to as the encoded nFG signals 61). The audio objects 61 each correspond to one of the vectors 57. The extraction unit 72 may pass the coded foreground V[k] vectors 57 to the V-vector reconstruction unit 74 and the encoded ambient HOA coefficients 59 along with the encoded nFG signals 61 to the psychoacoustic decoding unit 80.

The V-vector reconstruction unit 74 may represent a unit configured to reconstruct the V-vectors from the encoded foreground V[k] vectors 57. The V-vector reconstruction unit 74 may operate in a manner reciprocal to that of the quantization unit 52.

The psychoacoustic decoding unit 80 may operate in a manner reciprocal to the psychoacoustic audio coder unit 40 shown in the example of FIG. 3 so as to decode the encoded ambient HOA coefficients 59 and the encoded nFG signals 61 and thereby generate energy compensated ambient HOA coefficients 47′ and the interpolated nFG signals 49′ (which may also be referred to as interpolated nFG audio objects 49′). The psychoacoustic decoding unit 80 may pass the energy compensated ambient HOA coefficients 47′ to the fade unit 770 and the nFG signals 49′ to the foreground formulation unit 78.

The spatio-temporal interpolation unit 76 may operate in a manner similar to that described above with respect to the spatio-temporal interpolation unit 50. The spatio-temporal interpolation unit 76 may receive the reduced foreground V[k] vectors 55ₖ and perform the spatio-temporal interpolation with respect to the foreground V[k] vectors 55ₖ and the reduced foreground V[k−1] vectors 55ₖ₋₁ to generate interpolated foreground V[k] vectors 55ₖ″. The spatio-temporal interpolation unit 76 may forward the interpolated foreground V[k] vectors 55ₖ″ to the fade unit 770.

The extraction unit 72 may also output a signal 757 indicative of when one of the ambient HOA coefficients is in transition to fade unit 770, which may then determine which of the SHC_{BG} 47′ (where the SHC_{BG} 47′ may also be denoted as “ambient HOA channels 47” or “ambient HOA coefficients 47′) and the elements of the interpolated foreground V[k] vectors 55ₖ” are to be either faded-in or faded-out. In some examples, the fade unit 770 may operate opposite with respect to each of the ambient HOA coefficients 47′ and the elements of the interpolated foreground V[k] vectors 55ₖ″. That is, the fade unit 770 may perform a fade-in or fade-out, or both a fade-in or fade-out with respect to corresponding one of the ambient HOA coefficients 47′, while performing a fade-in or fade-out or both a fade-in and a fade-out, with respect to the corresponding one of the elements of the interpolated foreground V[k] vectors 55ₖ″. The fade unit 770 may output adjusted ambient HOA coefficients 47″ to the HOA coefficient formulation unit 82 and adjusted foreground V[k] vectors 55ₖ′″ to the foreground formulation unit 78. In this respect, the fade unit 770 represents a unit configured to perform a fade operation with respect to various aspects of the HOA coefficients or derivatives thereof, e.g., in the form of the ambient HOA coefficients 47′ and the elements of the interpolated foreground V[k] vectors 55ₖ″.

The foreground formulation unit 78 may represent a unit configured to perform matrix multiplication with respect to the adjusted foreground V[k] vectors 55ₖ′″ and the interpolated nFG signals 49′ to generate the foreground HOA coefficients 65. In this respect, the foreground formulation unit 78 may combine the audio objects 49′ (which is another way by which to denote the interpolated nFG signals 49′) with the vectors 55ₖ′″ to reconstruct the foreground or, in other words, predominant aspects of the HOA coefficients 11′. The foreground formulation unit 78 may perform a matrix multiplication of the interpolated nFG signals 49′ by the adjusted foreground V[k] vectors 55ₖ′″.

The HOA coefficient formulation unit 82 may represent a unit configured to combine the foreground HOA coefficients 65 to the adjusted ambient HOA coefficients 47″ so as to obtain the HOA coefficients 11′. The prime notation reflects that the HOA coefficients 11′ may be similar to but not the same as the HOA coefficients 11. The differences between the HOA coefficients 11 and 11′ may result from loss due to transmission over a lossy transmission medium, quantization or other lossy operations.

In accordance with the techniques described in this disclosure, the audio decoding device 24 may be configured to reconstruct the HOA coefficients 11′ based on the bitstream 21, which may include a harmonic coefficient ordering format indicator 67. For example, the audio decoding device 24 may obtain from the bitstream 21 a coded HOA audio signal (which may, e.g., refer to any combination of the coded foreground V[k] vectors 57, the encoded ambient HOA coefficients 59, the encoded nFG signals 61, and the background channel information 43) and a harmonic coefficient ordering format indicator 67, and decode the coded HOA audio signal based on the harmonic coefficient ordering format indicator obtained from the bitstream 21 to reconstruct the HOA coefficients 11′. The harmonic coefficient ordering format indicator 67 may indicate a harmonic coefficient ordering format for a source set of harmonic coefficients (e.g., the harmonic coefficients 11) that is used to generate the coded HOA audio signal.

As shown in FIG. 4, the audio decoding device 24 further includes a formatting unit 84. The extraction unit 72 may be configured to extract and/or obtain coded harmonic coefficients (which may, e.g., refer to any combination of the coded foreground V[k] vectors 57, the encoded ambient HOA coefficients 59, the encoded nFG signals 61, and the background channel information 43) and a harmonic coefficient ordering format indicator 67 from the bitstream 21. The formatting unit 84 may be configured to generate formatted harmonic coefficients 11′ based on the decoded harmonic coefficients 69 and the harmonic coefficient ordering format indicator 67.

The extraction unit 72 may include (although not shown for ease of illustration purposes) a coefficient format indicator parsing unit that may obtain the harmonic coefficient ordering format indicator 67 from the bitstream 21 and provide the harmonic coefficient ordering format indicator 67 to the formatting unit 84. In some examples, the extraction unit 72 may parse a header of an HOA audio frame to obtain one or more bits corresponding to the harmonic coefficient ordering format indicator 67. In further examples, the extraction unit 72 may detect whether an HOA audio frame is an access unit frame, and parse the header of the HOA audio frame to obtain one or more bits corresponding to the harmonic coefficient ordering format indicator 67 in response to detecting that the HOA audio frame is an access unit frame.

In some examples, the audio decoding device 24 may be configurable to decode a bitstream 21 that was generated from a source set of harmonic coefficients which has a harmonic coefficient ordering format that is different than a harmonic coefficient ordering format that the audio renderers 22 is designed to process (i.e., a target harmonic coefficient ordering format). When the audio decoding device 24 is configured in this manner, the harmonic coefficient ordering format in which the decoded harmonic coefficients 69 are formatted may not be the same as the target harmonic coefficient ordering format.

In such examples, the formatting unit 84 may reformat the decoded harmonic coefficients 69 based on the harmonic coefficient ordering format indicator 67 and a target harmonic coefficient ordering format. For example, the formatting unit 84 may determine whether the format of the decoded harmonic coefficients 69 matches the target harmonic coefficient ordering format, and reformat the decoded harmonic coefficients 69 such that the formatted harmonic coefficients 11′ are formatted according to the target harmonic coefficient ordering format.

In some examples, a first set of the decoded harmonic coefficients 69 are not formatted according to the harmonic coefficient ordering format indicated by the harmonic coefficient ordering format indicator 67, while a second set of the decoded harmonic coefficients 69 are formatted according to the harmonic coefficient ordering format indicated by the harmonic coefficient ordering format indicator 67. In such examples, the formatting unit 84 may selectively reformat the first decoded set of harmonic coefficients 69 based on whether the harmonic coefficient ordering format indicator 67 matches a target harmonic coefficient ordering format in order to generate a formatted decoded set of harmonic coefficients that is formatted according to the target harmonic coefficient ordering format.

In some examples, to selectively reformat the first decoded set of harmonic coefficients, the formatting unit 84 may, in some examples, determine whether the harmonic coefficient ordering format indicator 67 matches the target harmonic coefficient ordering format. In response to determining that the harmonic coefficient ordering format indicator 67 does not match the target harmonic coefficient ordering format, the formatting unit 84 may reformat the first decoded set of harmonic coefficients 69 to generate the second decoded set of harmonic coefficients (e.g., the formatted harmonic coefficients 11′) that is formatted according to the target harmonic coefficient ordering format. In response to determining that the harmonic coefficient ordering format indicator 67 matches the target harmonic coefficient ordering format, the formatting unit 84 may not reformat the first decoded set of harmonic coefficients (e.g., the decoded harmonic coefficients 69) to generate the second decoded set of harmonic coefficients (e.g., the formatted harmonic coefficients 11′) that is formatted according to the target harmonic coefficient ordering format. In some examples, the target harmonic coefficient ordering format may correspond to an input harmonic coefficient ordering format used by the selected one of the audio renderers 22.

In examples where the bitstream 21 includes coded spherical harmonic coefficients, the coded harmonic coefficients 21 may be referred to as coded spherical harmonic coefficients, the decoded harmonic coefficients 69 may be referred to as decoded spherical harmonic coefficients 69, and the formatted harmonic coefficients 11′ may be referred to as formatted spherical harmonic coefficients 11′.

In examples where the bitstream 21 includes coded cylindrical harmonic coefficients, the coded harmonic coefficients 21 may be referred to as coded cylindrical harmonic coefficients 21, the decoded harmonic coefficients 69 may be referred to as decoded cylindrical harmonic coefficients 69, and the formatted harmonic coefficients 11′ may be referred to as formatted cylindrical harmonic coefficients 11′.

In further examples, in addition to or in lieu of indicating the harmonic coefficient ordering format for a source set of harmonic coefficients, the harmonic coefficient ordering format indicator may indicate a dimensionality of a soundfield represented by the source set of harmonic coefficients. For example, the harmonic coefficient ordering format indicator 67 may indicate whether the source set of harmonic coefficients 11 are spherical harmonic coefficients or cylindrical harmonic coefficients. As another example, the harmonic coefficient ordering format indicator 67 may indicate whether the source set of coefficients are 2D HOA coefficients or 3D HOA coefficients.

In some examples, the extraction unit 72 may obtain a soundfield dimensionality indicator that indicates a dimensionality of the soundfield represented by the coded source set of harmonic coefficients. In some examples, the extraction unit 72 may obtain both a harmonic coefficient ordering format indicator and a soundfield dimensionality indicator from the bitstream. In further examples, the extraction unit 72 may obtain a harmonic coefficient ordering format indicator from the bitstream 21 without obtaining a soundfield dimensionality indicator from the bitstream 21. In additional examples, the extraction unit 72 may obtain a soundfield dimensionality indicator from the bitstream 21 without obtaining a harmonic coefficient ordering format indicator 67 from the bitstream 21.

In some examples, the extraction unit 72 may include a soundfield dimensionality indicator parsing unit (not shown) that is configured to obtain the soundfield dimensionality indicator from bitstream 21. In such examples, the extraction unit 72 may or may not further include the coefficient format indicator parsing unit.

In some examples, the extraction unit 72 may provide a soundfield dimensionality indicator to the formatting unit 84. In further examples, the formatting unit 84 may be configured to generate formatted harmonic coefficients 11′ based on one or both a soundfield dimensionality indicator and a harmonic coefficient ordering format indicator.

In this respect, the audio decoding device 24 may decode an HOA audio signal based on the harmonic coefficient ordering format indicator obtained from the bitstream 21. The harmonic coefficient ordering format indicator 67 may indicate one or both of a harmonic coefficient ordering format for a source set of harmonic coefficients and a dimensionality of soundfield for the source set of harmonic coefficients. In further examples, the audio decoding device 24 may decode an HOA audio signal based on a soundfield dimensionality indicator obtained from the bitstream 21. In additional examples, the audio decoding device 24 may decode an HOA audio signal based on a harmonic coefficient ordering format indicator 67 obtained from the bitstream 21 and a soundfield dimensionality indicator obtained from the bitstream 21.

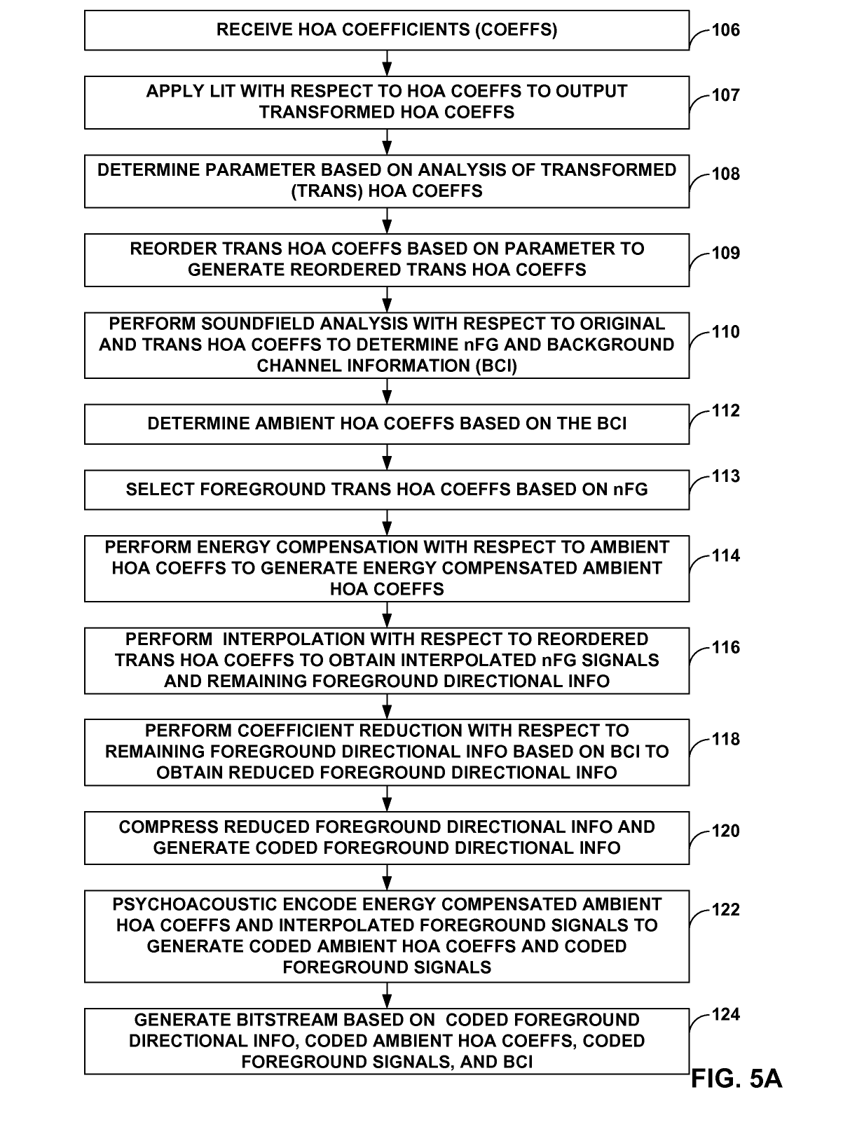

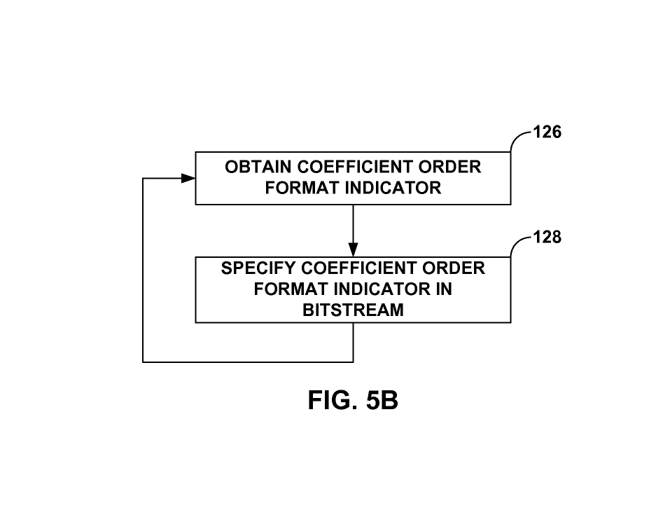

FIG. 5A is a flowchart illustrating exemplary operation of an audio encoding device, such as the audio encoding device 20 shown in the example of FIG. 3, in performing various aspects of the vector-based synthesis techniques described in this disclosure. Initially, the audio encoding device 20 receives the HOA coefficients 11 (106). The audio encoding device 20 may invoke the LIT unit 30, which may apply a LIT with respect to the HOA coefficients to output transformed HOA coefficients (e.g., in the case of SVD, the transformed HOA coefficients may comprise the US[k] vectors 33 and the V[k] vectors 35) (107).

The audio encoding device 20 may next invoke the parameter calculation unit 32 to perform the above described analysis with respect to any combination of the US[k] vectors 33, US[k−1] vectors 33, the V[k] and/or V[k−1] vectors 35 to identify various parameters in the manner described above. That is, the parameter calculation unit 32 may determine at least one parameter based on an analysis of the transformed HOA coefficients 33/35 (108).

The audio encoding device 20 may then invoke the reorder unit 34, which may reorder the transformed HOA coefficients (which, again in the context of SVD, may refer to the US[k] vectors 33 and the V[k] vectors 35) based on the parameter to generate reordered transformed HOA coefficients 33′/35′ (or, in other words, the US[k] vectors 33′ and the V[k] vectors 35′), as described above (109). The audio encoding device 20 may, during any of the foregoing operations or subsequent operations, also invoke the soundfield analysis unit 44. The soundfield analysis unit 44 may, as described above, perform a soundfield analysis with respect to the HOA coefficients 11 and/or the transformed HOA coefficients 33/35 to determine the total number of foreground channels (nFG) 45, the order of the background soundfield (N_{BG}) and the number (nBGa) and indices (i) of additional BG HOA channels to send (which may collectively be denoted as background channel information 43 in the example of FIG. 3) (109).

The audio encoding device 20 may also invoke the background selection unit 48. The background selection unit 48 may determine background or ambient HOA coefficients 47 based on the background channel information 43 (110). The audio encoding device 20 may further invoke the foreground selection unit 36, which may select the reordered US[k] vectors 33′ and the reordered V[k] vectors 35′ that represent foreground or distinct components of the soundfield based on nFG 45 (which may represent a one or more indices identifying the foreground vectors) (112).

The audio encoding device 20 may invoke the energy compensation unit 38. The energy compensation unit 38 may perform energy compensation with respect to the ambient HOA coefficients 47 to compensate for energy loss due to removal of various ones of the HOA coefficients by the background selection unit 48 (114) and thereby generate energy compensated ambient HOA coefficients 47′.

The audio encoding device 20 may also invoke the spatio-temporal interpolation unit 50. The spatio-temporal interpolation unit 50 may perform spatio-temporal interpolation with respect to the reordered transformed HOA coefficients 33′/35′ to obtain the interpolated foreground signals 49′ (which may also be referred to as the “interpolated nFG signals 49”) and the remaining foreground directional information 53 (which may also be referred to as the “V[k] vectors 53”) (116). The audio encoding device 20 may then invoke the coefficient reduction unit 46. The coefficient reduction unit 46 may perform coefficient reduction with respect to the remaining foreground V[k] vectors 53 based on the background channel information 43 to obtain reduced foreground directional information 55 (which may also be referred to as the reduced foreground V[k] vectors 55) (118).

The audio encoding device 20 may then invoke the quantization unit 52 to compress, in the manner described above, the reduced foreground V[k] vectors 55 and generate coded foreground V[k] vectors 57 (120).

The audio encoding device 20 may also invoke the psychoacoustic audio coder unit 40. The psychoacoustic audio coder unit 40 may psychoacoustic code each vector of the energy compensated ambient HOA coefficients 47′ and the interpolated nFG signals 49′ to generate encoded ambient HOA coefficients 59 and encoded nFG signals 61. The audio encoding device may then invoke the bitstream generation unit 42. The bitstream generation unit 42 may generate the bitstream 21 based on the coded foreground directional information 57, the coded ambient HOA coefficients 59, the coded nFG signals 61 and the background channel information 43.

FIG. 5B is a flowchart illustrating exemplary operation of an audio encoding device in performing the signaling techniques described in this disclosure. An audio encoding device, such as the audio encoding device 20 shown in FIGS. 2 and 3, may obtain a coefficient format order indicator 67 based on a source set of HOA coefficients 11 (126). That is, the bitstream generation unit 42 of the audio encoding device 20 may analyze the HOA coefficients 11. Based on the analysis of the HOA coefficients 11, the bitstream generation unit 42 may obtain the coefficient format order indicator 126. The bitstream generation unit 42 may obtain the indicator 67, which is indicative of, as one example, a symmetric harmonic coefficient order format indicator 67. The bitstream generation unit 42 may specify the coefficient order format indicator 67 in the bitstream 21 (128).

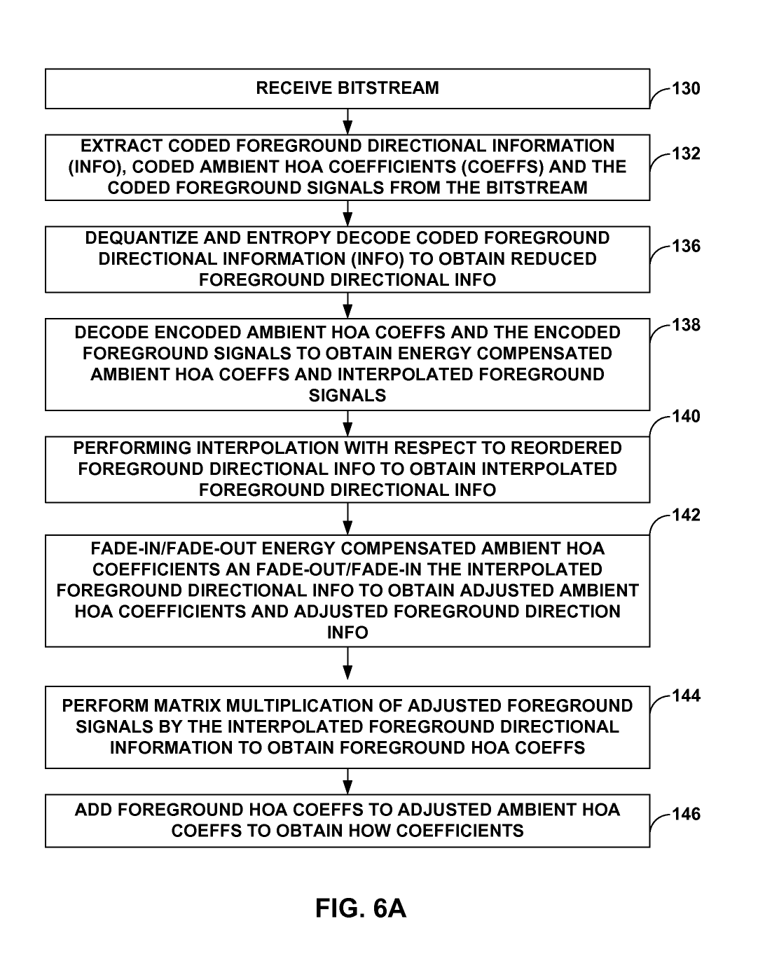

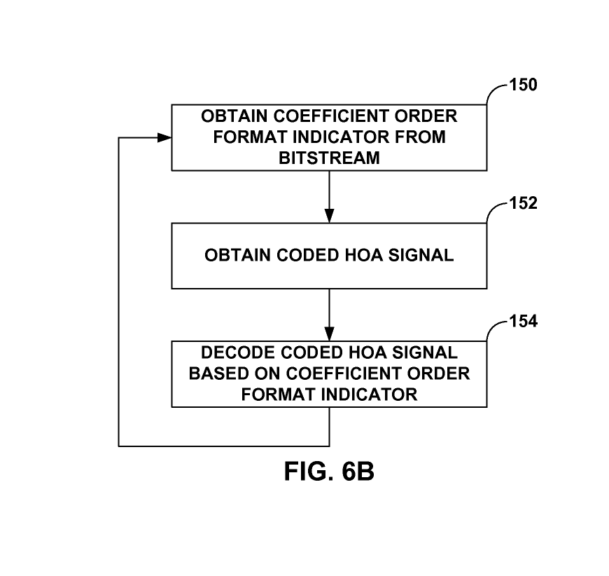

FIG. 6A is a flowchart illustrating exemplary operation of an audio decoding device, such as the audio decoding device 24 shown in FIG. 4, in performing various aspects of the techniques described in this disclosure. Initially, the audio decoding device 24 may receive the bitstream 21 (130). Upon receiving the bitstream, the audio decoding device 24 may invoke the extraction unit 72. Assuming for purposes of discussion that the bitstream 21 indicates that vector-based reconstruction is to be performed, the extraction unit 72 may parse the bitstream to retrieve the above noted information, passing the information to the vector-based reconstruction unit 92.

In other words, the extraction unit 72 may extract the coded foreground directional information 57 (which, again, may also be referred to as the coded foreground V[k] vectors 57), the coded ambient HOA coefficients 59 and the coded foreground signals (which may also be referred to as the coded foreground nFG signals 59 or the coded foreground audio objects 59) from the bitstream 21 in the manner described above (132).

The audio decoding device 24 may further invoke the dequantization unit 74. The dequantization unit 74 may entropy decode and dequantize the coded foreground directional information 57 to obtain reduced foreground directional information 55ₖ (136). The audio decoding device 24 may also invoke the psychoacoustic decoding unit 80. The psychoacoustic audio decoding unit 80 may decode the encoded ambient HOA coefficients 59 and the encoded foreground signals 61 to obtain energy compensated ambient HOA coefficients 47′ and the interpolated foreground signals 49′ (138). The psychoacoustic decoding unit 80 may pass the energy compensated ambient HOA coefficients 47′ to the fade unit 770 and the nFG signals 49′ to the foreground formulation unit 78.

The audio decoding device 24 may next invoke the spatio-temporal interpolation unit 76. The spatio-temporal interpolation unit 76 may receive the reordered foreground directional information 55ₖ′ and perform the spatio-temporal interpolation with respect to the reduced foreground directional information 55ₖ/55ₖ₋₁ to generate the interpolated foreground directional information 55ₖ″ (140). The spatio-temporal interpolation unit 76 may forward the interpolated foreground V[k] vectors 55ₖ″ to the fade unit 770.

The audio decoding device 24 may invoke the fade unit 770. The fade unit 770 may receive or otherwise obtain syntax elements (e.g., from the extraction unit 72) indicative of when the energy compensated ambient HOA coefficients 47′ are in transition (e.g., the AmbCoeffTransition syntax element). The fade unit 770 may, based on the transition syntax elements and the maintained transition state information, fade-in or fade-out the energy compensated ambient HOA coefficients 47′ outputting adjusted ambient HOA coefficients 47″ to the HOA coefficient formulation unit 82. The fade unit 770 may also, based on the syntax elements and the maintained transition state information, and fade-out or fade-in the corresponding one or more elements of the interpolated foreground V[k] vectors 55ₖ″ outputting the adjusted foreground V[k] vectors 55ₖ′″ to the foreground formulation unit 78 (142).

The audio decoding device 24 may invoke the foreground formulation unit 78. The foreground formulation unit 78 may perform matrix multiplication the nFG signals 49′ by the adjusted foreground directional information 55ₖ′″ to obtain the foreground HOA coefficients 65 (144). The audio decoding device 24 may also invoke the HOA coefficient formulation unit 82. The HOA coefficient formulation unit 82 may add the foreground HOA coefficients 65 to adjusted ambient HOA coefficients 47″ so as to obtain the HOA coefficients 11′ (146).

FIG. 6B is a flowchart illustrating exemplary operation of an audio decoding device in performing the coding techniques described in this disclosure. An audio decoding device, such as the audio decoding device 24 shown in FIGS. 2 and 4, may obtain a coefficient format order indicator 67 from the bitstream 21 (150). That is, the extraction unit 72 of the audio decoding device 24 may parse the indicator 67 from the bitstream 21. The extraction unit 72 may also obtain the coded HOA signal from the bitstream 21 in the manner described in more detail with respect to the example of FIG. 4 (152). The audio decoding device 24 may decode the coded HOA signal based on the coefficient format order indicator 67 (154).

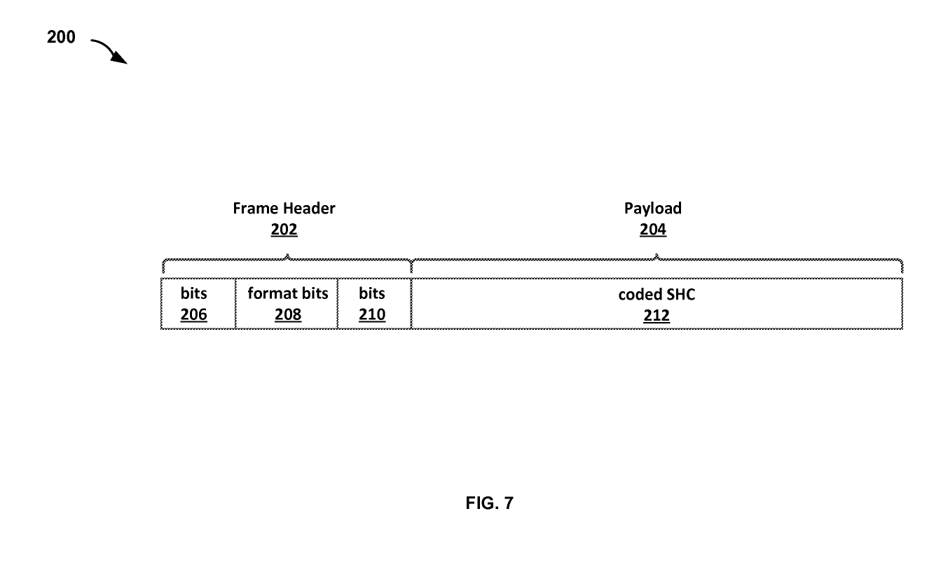

FIG. 7 is a conceptual diagram illustrating an HOA audio frame 200 that includes a harmonic coefficient ordering format indicator according to techniques described in this disclosure. As shown in the example of FIG. 7, the HOA audio frame 200 includes a frame header 202 and a payload 204. The frame header 202 includes zero or more bits 206, followed by one or more format bits 208, following by zero or more bits 210. The payload 204 includes coded harmonic coefficients (SHC) 212.

The one or more format bits 208 included in the frame header 202 may be an example of a harmonic coefficient ordering format indicator 67 as described above in more detail in this disclosure. In some examples, the one or more format bits 208 are one bit (i.e., a single bit). In further examples, the one or more format bits 208 are two bits. In additional examples, the one or more format bits 208 are three bits. In some examples, the zero or more bits 206 and the zero or more bits 210 may include one or more of the number of bytes field and the nbits field described above.

In some examples, the one or more format bits 208 may include a bit that indicates whether a set of harmonic coefficients is formatted according to a linear harmonic coefficient ordering format or a symmetric harmonic coefficient ordering format. In further examples, the one or more format bits 208 may include a bit that indicates a dimensionality of soundfield represented by the a set of harmonic coefficients. In additional examples, the one or more format bits 208 may include a first bit that indicates whether a set of harmonic coefficients is formatted according to a linear harmonic coefficient ordering format or a symmetric harmonic coefficient ordering format, and a second bit that indicates a dimensionality of soundfield represented by the set of harmonic coefficients.

In some examples, the one or more format bits 208 may include one or more bits that specify a harmonic coefficient ordering format for a set of harmonic coefficients and a dimensionality of soundfield represented by the set of harmonic coefficients. In further examples, the one or more format bits 208 may specify a harmonic coefficient ordering format without specifying a dimensionality of soundfield. In additional examples, the one or more format bits 208 may specify a dimensionality of soundfield without specifying a harmonic coefficient ordering format.

Two different schemes for ordering harmonic coefficients include an ambisonic channel number (ACN) linear order (i.e., a linear harmonic coefficient ordering format) and a symmetrical order used for instance in the Audio-Binary Format for Scene Description (BIFS) (i.e., a symmetric harmonic coefficient ordering format). In some examples, the techniques of this disclosure may be used to with the Moving Picture Experts Group (MPEG)-H standard. In some examples, the techniques of this disclosure may signal the order of the harmonic coefficients (e.g., either linear or symmetric). In further examples, the techniques of this disclosure may signal the order of the harmonic coefficients using a one-bit flag within an access unit or a comparable header section of a bitstream.

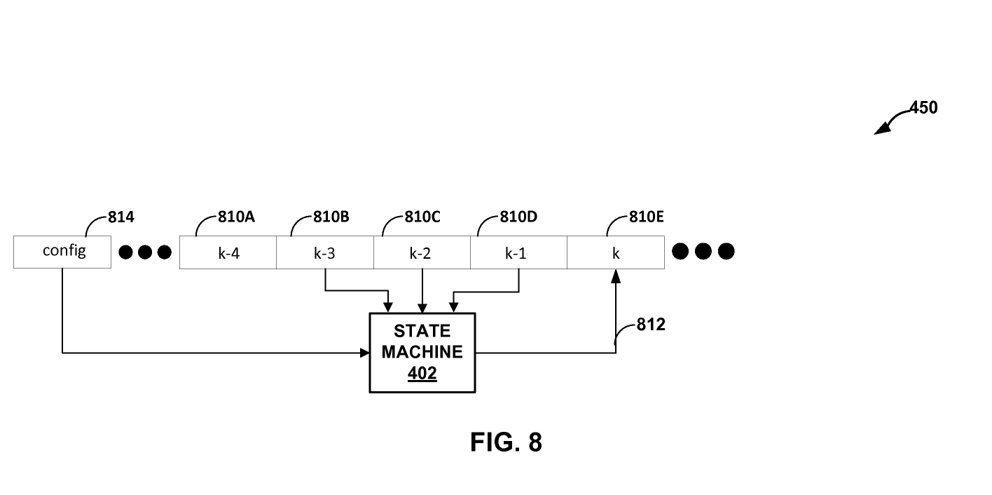

FIG. 8 is a diagram illustrating example frames for one or more channels of at least one bitstream in accordance with techniques described herein. The bitstream 450 includes frames 810A-810H that may each include one or more channels. The bitstream 450 may be one example of the bitstream 21 shown in the example of FIG. 7. In the example of FIG. 8, the audio decoding device 24 maintains state information, updating the state information to determine how to decode the current frame k. The audio decoding device 24 may utilize state information from config 814, and frames 810B-810D.

In other words, the audio encoding device 20 may include, within the bitstream generation unit 42 for example, the state machine 402 that maintains state information for encoding each of frames 810A-810E in that the bitstream generation unit 42 may specify syntax elements for each of frames 810A-810E based on the state machine 402, including the coefficient order format indicator 67.

The audio decoding device 24 may likewise include, within the bitstream extraction unit 72 for example, a similar state machine 402 that outputs syntax elements (some of which are not explicitly specified in the bitstream 21) based on the state machine 402, including the coefficient order format indicator 67. The state machine 402 of the audio decoding device 24 may operate in a manner similar to that of the state machine 402 of the audio encoding device 20. As such, the state machine 402 of the audio decoding device 24 may maintain state information, updating the state information based on the config 814 and, in the example of FIG. 8, the decoding of the frames 810B-810D. Based on the state information, the bitstream extraction unit 72 may extract the frame 810E based on the state information maintained by the state machine 402. The state information may provide a number of implicit syntax elements that the audio encoding device 20 may utilize when decoding the various transport channels of the frame 810E.

The foregoing techniques may be performed with respect to any number of different contexts and audio ecosystems. A number of example contexts are described below, although the techniques should be limited to the example contexts. One example audio ecosystem may include audio content, movie studios, music studios, gaming audio studios, channel based audio content, coding engines, game audio stems, game audio coding/rendering engines, and delivery systems.

The movie studios, the music studios, and the gaming audio studios may receive audio content. In some examples, the audio content may represent the output of an acquisition. The movie studios may output channel based audio content (e.g., in 2.0, 5.1, and 7.1) such as by using a digital audio workstation (DAW). The music studios may output channel based audio content (e.g., in 2.0, and 5.1) such as by using a DAW. In either case, the coding engines may receive and encode the channel based audio content based one or more codecs (e.g., AAC, AC3, Dolby True HD, Dolby Digital Plus, and DTS Master Audio) for output by the delivery systems. The gaming audio studios may output one or more game audio stems, such as by using a DAW. The game audio coding/rendering engines may code and or render the audio stems into channel based audio content for output by the delivery systems. Another example context in which the techniques may be performed comprises an audio ecosystem that may include broadcast recording audio objects, professional audio systems, consumer on-device capture, HOA audio format, on-device rendering, consumer audio, TV, and accessories, and car audio systems.

The broadcast recording audio objects, the professional audio systems, and the consumer on-device capture may all code their output using HOA audio format. In this way, the audio content may be coded using the HOA audio format into a single representation that may be played back using the on-device rendering, the consumer audio, TV, and accessories, and the car audio systems. In other words, the single representation of the audio content may be played back at a generic audio playback system (i.e., as opposed to requiring a particular configuration such as 5.1, 7.1, etc.), such as audio playback system 16.

Other examples of context in which the techniques may be performed include an audio ecosystem that may include acquisition elements, and playback elements. The acquisition elements may include wired and/or wireless acquisition devices (e.g., Eigen microphones), on-device surround sound capture, and mobile devices (e.g., smartphones and tablets). In some examples, wired and/or wireless acquisition devices may be coupled to mobile device via wired and/or wireless communication channel(s).

In accordance with one or more techniques of this disclosure, the mobile device may be used to acquire a soundfield. For instance, the mobile device may acquire a soundfield via the wired and/or wireless acquisition devices and/or the on-device surround sound capture (e.g., a plurality of microphones integrated into the mobile device). The mobile device may then code the acquired soundfield into the HOA coefficients for playback by one or more of the playback elements. For instance, a user of the mobile device may record (acquire a soundfield of) a live event (e.g., a meeting, a conference, a play, a concert, etc.), and code the recording into HOA coefficients.

The mobile device may also utilize one or more of the playback elements to playback the HOA coded soundfield. For instance, the mobile device may decode the HOA coded soundfield and output a signal to one or more of the playback elements that causes the one or more of the playback elements to recreate the soundfield. As one example, the mobile device may utilize the wireless and/or wireless communication channels to output the signal to one or more speakers (e.g., speaker arrays, sound bars, etc.). As another example, the mobile device may utilize docking solutions to output the signal to one or more docking stations and/or one or more docked speakers (e.g., sound systems in smart cars and/or homes). As another example, the mobile device may utilize headphone rendering to output the signal to a set of headphones, e.g., to create realistic binaural sound.

In some examples, a particular mobile device may both acquire a 3D soundfield and playback the same 3D soundfield at a later time. In some examples, the mobile device may acquire a 3D soundfield, encode the 3D soundfield into HOA, and transmit the encoded 3D soundfield to one or more other devices (e.g., other mobile devices and/or other non-mobile devices) for playback.

Yet another context in which the techniques may be performed includes an audio ecosystem that may include audio content, game studios, coded audio content, rendering engines, and delivery systems. In some examples, the game studios may include one or more DAWs which may support editing of HOA signals. For instance, the one or more DAWs may include HOA plugins and/or tools which may be configured to operate with (e.g., work with) one or more game audio systems. In some examples, the game studios may output new stem formats that support HOA. In any case, the game studios may output coded audio content to the rendering engines which may render a soundfield for playback by the delivery systems.

The techniques may also be performed with respect to exemplary audio acquisition devices. For example, the techniques may be performed with respect to an Eigen microphone which may include a plurality of microphones that are collectively configured to record a 3D soundfield. In some examples, the plurality of microphones of Eigen microphone may be located on the surface of a substantially spherical ball with a radius of approximately 4 cm. In some examples, the audio encoding device 20 may be integrated into the Eigen microphone so as to output a bitstream 21 directly from the microphone.

Another exemplary audio acquisition context may include a production truck which may be configured to receive a signal from one or more microphones, such as one or more Eigen microphones. The production truck may also include an audio encoder, such as audio encoder 20 of FIG. 3.

The mobile device may also, in some instances, include a plurality of microphones that are collectively configured to record a 3D soundfield. In other words, the plurality of microphone may have X, Y, Z diversity. In some examples, the mobile device may include a microphone which may be rotated to provide X, Y, Z diversity with respect to one or more other microphones of the mobile device. The mobile device may also include an audio encoder, such as audio encoder 20 of FIG. 3.

A ruggedized video capture device may further be configured to record a 3D soundfield. In some examples, the ruggedized video capture device may be attached to a helmet of a user engaged in an activity. For instance, the ruggedized video capture device may be attached to a helmet of a user whitewater rafting. In this way, the ruggedized video capture device may capture a 3D soundfield that represents the action all around the user (e.g., water crashing behind the user, another rafter speaking in front of the user, etc. . . . ).

The techniques may also be performed with respect to an accessory enhanced mobile device, which may be configured to record a 3D soundfield. In some examples, the mobile device may be similar to the mobile devices discussed above, with the addition of one or more accessories. For instance, an Eigen microphone may be attached to the above noted mobile device to form an accessory enhanced mobile device. In this way, the accessory enhanced mobile device may capture a higher quality version of the 3D soundfield than just using sound capture components integral to the accessory enhanced mobile device.

Example audio playback devices that may perform various aspects of the techniques described in this disclosure are further discussed below. In accordance with one or more techniques of this disclosure, speakers and/or sound bars may be arranged in any arbitrary configuration while still playing back a 3D soundfield. Moreover, in some examples, headphone playback devices may be coupled to a decoder 24 via either a wired or a wireless connection. In accordance with one or more techniques of this disclosure, a single generic representation of a soundfield may be utilized to render the soundfield on any combination of the speakers, the sound bars, and the headphone playback devices.

A number of different example audio playback environments may also be suitable for performing various aspects of the techniques described in this disclosure. For instance, a 5.1 speaker playback environment, a 2.0 (e.g., stereo) speaker playback environment, a 9.1 speaker playback environment with full height front loudspeakers, a 22.2 speaker playback environment, a 16.0 speaker playback environment, an automotive speaker playback environment, and a mobile device with ear bud playback environment may be suitable environments for performing various aspects of the techniques described in this disclosure.

In accordance with one or more techniques of this disclosure, a single generic representation of a soundfield may be utilized to render the soundfield on any of the foregoing playback environments. Additionally, the techniques of this disclosure enable a rendered to render a soundfield from a generic representation for playback on the playback environments other than that described above. For instance, if design considerations prohibit proper placement of speakers according to a 7.1 speaker playback environment (e.g., if it is not possible to place a right surround speaker), the techniques of this disclosure enable a render to compensate with the other 6 speakers such that playback may be achieved on a 6.1 speaker playback environment.

Moreover, a user may watch a sports game while wearing headphones. In accordance with one or more techniques of this disclosure, the 3D soundfield of the sports game may be acquired (e.g., one or more Eigen microphones may be placed in and/or around the baseball stadium), HOA coefficients corresponding to the 3D soundfield may be obtained and transmitted to a decoder, the decoder may reconstruct the 3D soundfield based on the HOA coefficients and output the reconstructed 3D soundfield to a renderer, the renderer may obtain an indication as to the type of playback environment (e.g., headphones), and render the reconstructed 3D soundfield into signals that cause the headphones to output a representation of the 3D soundfield of the sports game.

In each of the various instances described above, it should be understood that the audio encoding device 20 may perform a method or otherwise comprise means to perform each step of the method for which the audio encoding device 20 is configured to perform In some instances, the means may comprise one or more processors. In some instances, the one or more processors may represent a special purpose processor configured by way of instructions stored to a non-transitory computer-readable storage medium. In other words, various aspects of the techniques in each of the sets of encoding examples may provide for a non-transitory computer-readable storage medium having stored thereon instructions that, when executed, cause the one or more processors to perform the method for which the audio encoding device 20 has been configured to perform.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media. Data storage media may be any available media that can be accessed by one or more computers or one or more processors to retrieve instructions, code and/or data structures for implementation of the techniques described in this disclosure. A computer program product may include a computer-readable medium.

Likewise, in each of the various instances described above, it should be understood that the audio decoding device 24 may perform a method or otherwise comprise means to perform each step of the method for which the audio decoding device 24 is configured to perform. In some instances, the means may comprise one or more processors. In some instances, the one or more processors may represent a special purpose processor configured by way of instructions stored to a non-transitory computer-readable storage medium. In other words, various aspects of the techniques in each of the sets of encoding examples may provide for a non-transitory computer-readable storage medium having stored thereon instructions that, when executed, cause the one or more processors to perform the method for which the audio decoding device 24 has been configured to perform.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various aspects of the techniques have been described. These and other aspects of the techniques are within the scope of the following claims.

1. A method of decoding a coded higher-order ambisonic (HOA) audio signal, the method comprising:
obtaining, from a bitstream indicative of the coded HOA audio signal, a harmonic coefficient ordering format indicator indicative of a symmetric harmonic coefficient ordering format for a source set of HOA coefficients from which the coded HOA audio signal is generated; and
decoding the coded HOA audio signal based on the symmetric harmonic coefficient ordering format indicator.

2. The method of claim 1,
wherein each of the harmonic coefficients is associated with a respective harmonic basis function having a respective order and a respective sub-order, and
wherein the symmetric harmonic coefficient ordering format specifies a sequence of harmonic coefficients in which the orders corresponding to the harmonic coefficients monotonically increase from start to end of the sequence, magnitudes of the sub-orders corresponding to harmonic coefficients that have the same order monotonically decrease from start to end of a sub-sequence formed by the harmonic coefficients have the same order, and for sub-orders of equal magnitude, positive sub-orders occur prior to negative sub-orders.

3. The method of claim 1,
wherein each of the harmonic coefficients is associated with a respective harmonic basis function having a respective order and a respective sub-order, and
wherein the symmetric harmonic coefficient ordering format specifies a sequence of harmonic coefficients in which the harmonic coefficients with lower orders occur prior to the harmonic coefficients with higher orders, and for each order, the harmonic coefficients with higher sub-order magnitudes occur prior to harmonic coefficients with lower sub-order magnitudes, and for sub-orders of equal magnitude, positive sub-orders occur prior to negative sub-orders.

4. The method of claim 1,
wherein the harmonic coefficients comprise spherical harmonic coefficients,
wherein each of the spherical harmonic coefficients comprises a spherical harmonic coefficient that is associated with a respective spherical harmonic basis function having a respective order and a respective sub-order, and
wherein the symmetric harmonic coefficient ordering format specifies a sequence of spherical harmonic coefficients in which spherical harmonic coefficients with symmetric sub-orders are adjacent to each other.

5. The method of claim 1,
wherein the harmonic coefficients comprise spherical harmonic coefficients,
wherein the symmetric harmonic coefficient ordering format specifies a sequence of spherical harmonic coefficients in which a symmetric ordering index for the spherical harmonic coefficients increases from start to end of the sequence, and
wherein the symmetric ordering index is defined based on the following mapping:
$${b}_{n , m} = \{ \begin{matrix}{n}^{2} + 2 n - 2 m , & m \geq 0 \\ {n}^{2} + 2 n + 2 m + 1 , & m < 0\end{matrix}$$
where b_{n,m} is the symmetric ordering index associated with the one of the spherical harmonic coefficients of order n and sub-order m.

6. The method of claim 1, further comprising:
obtaining, from the bitstream, a harmonic coefficient ordering format indicator indicative of a linear harmonic coefficient ordering format; and
decoding the first coded HOA audio signal or the second coded HOA audio signal based on the linear harmonic coefficient ordering format indicator.

7. The method of claim 6,
wherein the harmonic coefficients comprise spherical harmonic coefficients,
wherein the linear harmonic coefficient ordering format specifies a sequence of spherical harmonic coefficients in which a linear ordering index for the spherical harmonic coefficients increases from start to end of the sequence, and
wherein the linear ordering index is defined based on the following mapping:
a_{n,m}=n²+n+m
where a_{n,m} is the linear ordering index associated with the one of the spherical harmonic coefficients of order n and sub-order m.

8. The method of claim 1, wherein decoding the coded HOA audio signal comprises:
decoding the coded HOA audio signal to generate a first decoded set of harmonic coefficients that is formatted according to the harmonic coefficient ordering format indicated by the harmonic coefficient ordering format indicator; and
selectively reformatting the first decoded set of harmonic coefficients based on whether the harmonic coefficient ordering format matches a target harmonic coefficient ordering format to generate a second decoded set of harmonic coefficients that is formatted according to the target harmonic coefficient ordering format.

9. The method of claim 8, wherein selectively reformatting the first decoded set of harmonic coefficients comprises:
determining whether the harmonic coefficient ordering format matches the target harmonic coefficient ordering format;
reformatting the first decoded set of harmonic coefficients to generate the second decoded set of harmonic coefficients that is formatted according to the target harmonic coefficient ordering format in response to determining that the harmonic coefficient ordering format does not match the target harmonic coefficient ordering format; and
not reformatting the first decoded set of harmonic coefficients to generate the second decoded set of harmonic coefficients that is formatted according to the target harmonic coefficient ordering format in response to determining that the harmonic coefficient ordering format matches the target harmonic coefficient ordering format.

10. The method of claim 8, wherein the target harmonic coefficient ordering format corresponds to an input harmonic coefficient ordering format used by an audio rendering unit.

11. An audio decoding device comprising:
a memory configured to store a bitstream indicative of a coded higher-order ambisonic (HOA) audio signal; and
one or more processors configured to obtain, from the bitstream, a harmonic coefficient ordering format indicator indicative of a symmetric harmonic coefficient ordering format for a source set of HOA coefficients from which the coded HOA audio signal is generated, and decode the coded HOA audio signal based on the symmetric harmonic coefficient ordering format indicator.

12. The audio decoding device of claim 11,
wherein each of the harmonic coefficients is associated with a respective harmonic basis function having a respective order and a respective sub-order, and
wherein the symmetric harmonic coefficient ordering format specifies a sequence of harmonic coefficients in which the orders corresponding to the harmonic coefficients monotonically increase from start to end of the sequence, magnitudes of the sub-orders corresponding to harmonic coefficients that have the same order monotonically decrease from start to end of a sub-sequence formed by the harmonic coefficients have the same order, and for sub-orders of equal magnitude, positive sub-orders occur prior to negative sub-orders.

13. The audio decoding device of claim 11,
wherein each of the harmonic coefficients is associated with a respective harmonic basis function having a respective order and a respective sub-order, and
wherein the symmetric harmonic coefficient ordering format specifies a sequence of harmonic coefficients in which the harmonic coefficients with lower orders occur prior to the harmonic coefficients with higher orders, and for each order, the harmonic coefficients with higher sub-order magnitudes occur prior to harmonic coefficients with lower sub-order magnitudes, and for sub-orders of equal magnitude, positive sub-orders occur prior to negative sub-orders.

14. The audio decoding device of claim 11,
wherein the harmonic coefficients comprise spherical harmonic coefficients, wherein each of the spherical harmonic coefficients comprises a spherical harmonic coefficient that is associated with a respective spherical harmonic basis function having a respective order and a respective sub-order, and
wherein the symmetric harmonic coefficient ordering format specifies a sequence of spherical harmonic coefficients in which spherical harmonic coefficients with symmetric sub-orders are adjacent to each other.

15. A method of encoding a higher-order ambisonic (HOA) audio signal, the method comprising:
generating a bitstream indicative of a coded HOA audio signal and a harmonic coefficient ordering format indicator indicative of a symmetric harmonic coefficient ordering format for a source set of harmonic coefficients from which the coded HOA audio signal is generated.

16. The method of claim 15,
wherein each of the harmonic coefficients is associated with a respective harmonic basis function having a respective order and a respective sub-order, and
wherein the symmetric harmonic coefficient ordering format specifies a sequence of harmonic coefficients in which the orders corresponding to the harmonic coefficients monotonically increase from start to end of the sequence, magnitudes of the sub-orders corresponding to harmonic coefficients that have the same order monotonically decrease from start to end of a sub-sequence formed by the harmonic coefficients have the same order, and for sub-orders of equal magnitude, positive sub-orders occur prior to negative sub-orders.

17. The method of claim 15,
wherein the harmonic coefficients comprise spherical harmonic coefficients,
wherein each of the spherical harmonic coefficients comprises a spherical harmonic coefficient that is associated with a respective spherical harmonic basis function having a respective order and a respective sub-order, and
wherein the symmetric harmonic coefficient ordering format specifies a sequence of spherical harmonic coefficients in which spherical harmonic coefficients with symmetric sub-orders are adjacent to each other.

18. The method of claim 15,
wherein the harmonic coefficients comprise spherical harmonic coefficients, and
wherein the symmetric ordering index is defined based on the following mapping:
$${b}_{n , m} = \{ \begin{matrix}{n}^{2} + 2 n - 2 m , & m \geq 0 \\ {n}^{2} + 2 n + 2 m + 1 , & m < 0\end{matrix}$$
where b_{n,m} is the symmetric ordering index associated with the one of the spherical harmonic coefficients of order n and sub-order m.

19. The method of claim 15, further comprising generating the bitstream to further include a harmonic coefficient ordering format indicator indicative of a linear harmonic coefficient ordering format,
wherein the harmonic coefficients comprise spherical harmonic coefficients,
wherein the linear harmonic coefficient ordering format specifies a sequence of spherical harmonic coefficients in which a linear ordering index for the spherical harmonic coefficients increases from start to end of the sequence, and
wherein the linear ordering index is defined based on the following mapping:
a_{n,m}=n²+n+m
where a_{n,m} is the linear ordering index associated with the one of the spherical harmonic coefficients of order n and sub-order m.

20. An audio encoding device comprising:
a memory configured to store a bitstream indicative of a coded higher-order ambisonic (HOA) audio signal; and
one or more processors configured to generate the bitstream to include a harmonic coefficient ordering format indicator indicative of a symmetric harmonic coefficient ordering format for a source set of harmonic coefficients from which the coded HOA audio signal is generated.

21. The audio encoding device of claim 20,
wherein each of the harmonic coefficients is associated with a respective harmonic basis function having a respective order and a respective sub-order, and
wherein the symmetric harmonic coefficient ordering format specifies a sequence of harmonic coefficients in which the orders corresponding to the harmonic coefficients monotonically increase from start to end of the sequence, magnitudes of the sub-orders corresponding to harmonic coefficients that have the same order monotonically decrease from start to end of a sub-sequence formed by the harmonic coefficients have the same order, and for sub-orders of equal magnitude, positive sub-orders occur prior to negative sub-orders.

22. The audio encoding device of claim 20,
wherein the harmonic coefficients comprise spherical harmonic coefficients,
wherein each of the spherical harmonic coefficients comprises a spherical harmonic coefficient that is associated with a respective spherical harmonic basis function having a respective order and a respective sub-order, and
wherein the symmetric harmonic coefficient ordering format specifies a sequence of spherical harmonic coefficients in which spherical harmonic coefficients with symmetric sub-orders are adjacent to each other.

23. The audio encoding device of claim 20,
wherein the harmonic coefficients comprise spherical harmonic coefficients, and
wherein the symmetric ordering index is defined based on the following mapping:
$${b}_{n , m} = \{ \begin{matrix}{n}^{2} + 2 n - 2 m , & m \geq 0 \\ {n}^{2} + 2 n + 2 m + 1 , & m < 0\end{matrix}$$
where b_{n,m} is the symmetric ordering index associated with the one of the spherical harmonic coefficients of order n and sub-order m.
